(19) United States
(12) Patent Application Publication
(10) Pub. No.: US 2026/0236932 A1
(43) Pub. Date: Aug. 13, 2026

(54) SYSTEMS AND METHODS FOR AI-POWERED SUBSCRIBER SUPPORT

(71) Applicant: Boost SubscriberCo L.L.C., Englewood, CO (US)

(72) Inventors: Vinay W. Tiwari, Lone Tree, CO (US); Madhu Sowmya Bandi, Englewood, CO (US); Xinyu Lou, Lone Tree, CO (US); Shubham Singh, Lone Tree, CO (US)

(21) Appl. No.: 19/051,017

(22) Filed: Feb. 11, 2025

(51) Int. Cl. G06Q 30/015; G06F 16/28; G06F 40/103; G06F 40/35; G06F 40/40

(52) U.S. Cl. CPC G06Q 30/015; G06F 16/285; G06F 40/35; G06F 40/40; G06F 40/103

(57) ABSTRACT

A disclosed method may include (i) receiving chat transcripts from multiple chat groups for a communications service provider where the chat transcripts include distinct support agent accounts of the communications service provider exchanging information about support tickets issued by subscribers who subscribe to a technological service provided by the communications service provider and (ii) prompting a large language model (LLM) such that initial issues are generated based on the chat transcripts.

### BRIEF SUMMARY

This disclosure is generally directed to systems, methods, and computer-readable media relating to AI-powered subscriber support. In the realm of customer support and service, organizations may face numerous challenges in managing and optimizing their support agent interactions. One such challenge may involve the efficient handling of large volumes of support tickets and inquiries across multiple chat groups within an enterprise. Support agents may exchange information about various issues reported by subscribers who subscribe to a technological service provided by the enterprise, such as a telecommunications network and/or satellite television service. These interactions may generate substantial amounts of data that, if properly analyzed, could yield valuable insights for improving customer support processes and overall service quality. The analysis of this data may present several difficulties, including the need to process unstructured text, identify common themes across diverse conversations, and extract actionable insights in a timely manner. Additionally, the sheer volume of chat messages generated daily may overwhelm other analysis methods, potentially leading to missed opportunities for process improvement and customer satisfaction enhancement. In some scenarios, support agents may struggle to quickly access relevant information from past interactions, resulting in longer reservice times and inconsistent responses to similar issues. The dynamic nature of customer support interactions may also pose challenges, as new issues and variations of existing problems may emerge rapidly, requiring continuous adaptation of support strategies and knowledge bases.

A potential difficulty in this scenario may lie in the extraction and standardization of meaningful information from diverse and often unstructured chat conversations. Support agents may discuss similar issues using different terminology and/or context, making it challenging to identify recurring problems and/or standardize services. This lack of standardization could lead to inconsistencies in problem-solving techniques, increased reservice times, and potential customer dissatisfaction. Moreover, valuable knowledge gained from resolving specific issues may remain siloed within individual chat groups, preventing its wider dissemination and application across the organization. The absence of a centralized, easily accessible knowledge base may result in support agents repeatedly solving the same problems, rather than leveraging existing services. This inefficiency may not only impact the productivity of the support team but also the overall customer experience, as subscribers may experience longer wait times and/or inconsistent reservice techniques for their reported issues. Furthermore, without a systematic way to analyze and learn from past interactions, organizations may miss out on opportunities to proactively address recurring issues, improve their products and/or services, and streamline their support processes. The lack of real-time insights into emerging trends and patterns in customer inquiries may hinder the organization's ability to allocate resources effectively and respond promptly to evolving customer needs.

One technique that may address these challenges involves the application of generative artificial intelligence models to analyze support agent chat messages. This technique may enable the extraction of standardized topics based on commonalities between multiple and distinct topics submitted by different subscribers and/or discussed by support agents. By identifying these standardized topics, organizations may gain a clearer understanding of the most frequent issues faced by their customers and develop more consistent reservice strategies. The use of generative AI models may allow for the processing of large volumes of unstructured text data, identifying patterns and trends that might be difficult and/or time-consuming for human analysts to detect. This automated analysis may not only save time and resources but also provide more objective and comprehensive insights into the support process. Additionally, the continuous learning capability of these AI models may enable them to adapt to evolving customer issues and support agent techniques over time, ensuring that the analysis remains relevant and valuable as the organization's products, services, and customer base change. The AI-powered system may also facilitate the creation of a dynamic knowledge base that evolves based on real-time interactions, potentially reducing the time and effort required to maintain and update support documentation manually.

Another service to the challenges faced in support agent interactions may involve the implementation of a comprehensive temporal analysis system. This system may provide a detailed view of chat volume patterns, issue emergence, and reservice timelines across different time periods. By visualizing these temporal aspects, support managers may gain valuable insights into peak hours, correlations between issue types and specific time periods, and opportunities for optimizing staffing based on historical patterns. The temporal analysis may also help identify anomalies or unusual patterns that might require special attention, such as sudden spikes in certain types of inquiries or unexpected lulls in support requests. This information may enable organizations to proactively adjust their support strategies, allocate resources more efficiently, and potentially predict and prepare for future support needs based on historical trends and seasonal patterns. The system may also track the lifecycle of individual issues from emergence to reservice, providing insights into average reservice times and potential bottlenecks in the support process. By analyzing these patterns over time, organizations may identify opportunities for process improvements, such as developing targeted training programs for support agents or implementing automated services for commonly recurring issues during specific time periods.

To address the challenge of knowledge management and dissemination within support teams, a service may involve the development of an AI-powered knowledge base evolution and impact analysis system. This system may track the growth of the knowledge base over time, identifying the most frequently accessed articles and assessing their impact on support efficiency metrics such as average reservice time and first contact reservice rate. By providing a clear visualization of how the knowledge base contributes to improved support outcomes, organizations may better understand the value of their documentation efforts and identify areas where additional resources may be needed. The system may also generate recommendations for new knowledge base articles based on recurring issues identified in support agent chats, ensuring that the knowledge base remains up-to-date and relevant. Furthermore, the impact analysis may help support managers make data-driven decisions about resource allocation for knowledge base maintenance and expansion, potentially leading to more efficient use of time and personnel. The system may also facilitate the identification of knowledge gaps by highlighting areas where support agents frequently struggle to find relevant information, prompting the creation of new documentation or the improvement of existing resources.

An additional technique for optimizing support agent interactions may involve the implementation of an AI-powered chat analysis and optimization system. This system may provide real-time analysis of ongoing support conversations, offering immediate insights and recommendations to support agents as they interact with customers. By identifying the nature of the issue being discussed and cross-referencing it with previous similar cases, the system may suggest potential services or direct agents to relevant knowledge base articles. This real-time assistance may help reduce reservice times and improve the consistency of support provided across different agents and interactions. The system may also identify opportunities for process improvements by analyzing patterns in support interactions, such as common escalation points or frequently repeated steps in troubleshooting processes. These insights may lead to the development of more streamlined support workflows or the creation of automated tools to handle routine tasks. Additionally, the system may provide personalized training recommendations for individual support agents based on their performance and the types of issues they commonly handle, potentially leading to more targeted and effective skill development within the support team.

In some examples, a method includes (i) receiving chat transcripts from multiple chat groups for a communications service provider where the chat transcripts include distinct support agent accounts of the communications service provider exchanging information about support tickets issued by subscribers who subscribe to a technological service provided by the communications service provider, (ii) prompting a large language model (LLM) such that initial issues are generated based on the chat transcripts, (iii) vectorizing the initial issues through semantic vector embedding, (iv) clustering the vectorized initial issues such that issue clusters are formed, (v) applying a same or different LLM to each respective issue cluster of the issue clusters such that a respective generalized issue from the respective issue cluster is extracted and populated into a standardized knowledge database, and (vi) resolving, by a support agent account, a support ticket at least in part by referencing a dashboard that provides an interface to the standardized knowledge database.

In some examples, the method further comprises storing a standardized answer associated with the respective generalized issue in the standardized knowledge database.

In some examples, the method further comprises identifying a repeating generalized issue occurring across multiple time periods in the chat transcripts and automatically generating, in response to identifying the repeating generalized issue, a draft knowledge base article that includes a standardized service procedure that addresses the repeating generalized issue.

In some examples, the method further comprises refining or engineering a prompt for prompting the LLM based on feedback from the support agent accounts.

In some examples, the method further comprises converting the chat transcripts into a sequential format by performing at least one of: extracting multiple distinct threads from a single chat transcript of the chat transcripts such that the multiple distinct threads are separated from an interwoven state in the single chat transcript, extracting a single chat thread from across multiple chat transcripts of the chat transcripts such that the single chat thread is assembled from portions dispersed across the multiple chat transcripts, grouping messages across multiple chat transcripts based on semantic similarity to a respective generalized issue, standardizing a format of the chat transcripts from various sources into a consistent structure, or normalizing timestamps across multiple chat transcripts to a standard time zone.

In some examples, the dashboard comprises: a leaderboard of top issues based on a frequency of occurrence of respective generalized issues, a heat map that visualizes a distribution of the respective generalized issues across different time periods, identification of repeating issues that occur across multiple time periods, suggestions for standardizing services to frequently occurring issues, or identification of issues that should be added to the standardized knowledge database due to their frequency or impact.

In some examples, the dashboard comprises a trend analysis of a particular generalized issue over time.

In some examples, the method further comprises applying a data estate layer comprising a chat space that stores the chat transcripts from the multiple chat groups or a data engineering pipeline that schedules or manages data flow from the chat space to subsequent processing layers.

In some examples, the method further comprises applying a pre-processing layer to the chat transcripts prior to prompting the LLM, the pre-processing layer comprising: data transformation that converts the chat transcripts into a structured format, anonymization that removes personally identifiable information from the chat transcripts, or text cleaning that removes irrelevant characters, standardizes formatting, or corrects common spelling or grammatical errors.

In some examples, clustering the vectorized initial issues comprises: agglomerative clustering that groups similar vectorized initial issues based on their vector representations, calculating a similarity score between clustered vectorized initial issues, or filtering clusters based on the similarity score.

In some examples, the technological service comprises a fifth generation or later cellular network service or a satellite television service.

In some examples, the method further comprises updating the standardized knowledge database based on a resolution of a support ticket.

In some examples, the dashboard provides a real-time update of an issue that is emerging across the multiple chat groups.

In some examples, the method comprises generating a confidence score for each respective generalized issue that indicates a level of certainty in accuracy of the respective generalized issue.

In some examples, the method further comprises fine tuning the LLM based on feedback from a support agent account.

In some examples, the method further comprises automatically generating an alert when a frequency of a particular respective generalized issue exceeds a predetermined threshold and sending the alert to a corresponding support team.

In some examples, a non-transitory computer-readable medium has instructions stored thereon that, when executed by at least one physical computing processor, cause a computing device to perform operations comprising (i) receiving chat transcripts from multiple chat groups for a communications service provider where the chat transcripts include distinct support agent accounts of the communications service provider exchanging information about support tickets issued by subscribers who subscribe to a technological service provided by the communications service provider, (ii) prompting a large language model (LLM) such that initial issues are generated based on the chat transcripts, (iii) vectorizing the initial issues through semantic vector embedding, (iv) clustering the vectorized initial issues such that issue clusters are formed, (v) applying a same or different LLM to each respective issue cluster of the issue clusters such that a respective generalized issue from the respective issue cluster is extracted and populated into a standardized knowledge database, and (vi) resolving, by a support agent account, a support ticket at least in part by referencing a dashboard that provides an interface to the standardized knowledge database.

In some examples, a system comprises at least one physical computing processor of a computing device and a non-transitory computer-readable medium that has instructions stored thereon that, when executed by the at least one physical computing processor, cause the computing device to perform operations comprising (i) receiving chat transcripts from multiple chat groups for a communications service provider where the chat transcripts include distinct support agent accounts of the communications service provider exchanging information about support tickets issued by subscribers who subscribe to a technological service provided by the communications service provider, (ii) prompting a large language model (LLM) such that initial issues are generated based on the chat transcripts, (iii) vectorizing the initial issues through semantic vector embedding, (iv) clustering the vectorized initial issues such that issue clusters are formed, (v) applying a same or different LLM to each respective issue cluster of the issue clusters such that a respective generalized issue from the respective issue cluster is extracted and populated into a standardized knowledge database, and (vi) resolving, by a support agent account, a support ticket at least in part by referencing a dashboard that provides an interface to the standardized knowledge database.

### BRIEF DESCRIPTION OF THE DRAWINGS

For a better understanding of the present invention, reference will be made to the following Detailed Description, which is to be read in association with the accompanying drawings:

FIG. 1 shows an example flow diagram for a method relating to AI-powered subscriber support.

FIG. 2 illustrates an examples of a thread reply usage chart, a daily message count chart, and a chat support transcript example.

FIG. 3 presents example chat transcripts that may demonstrate various support interactions.

FIG. 4A depicts an example architecture diagram.

FIG. 4B illustrates an example process of AI-powered issue extraction and vectorization from chat transcripts.

FIG. 4C shows an example of cluster analysis and generalized issue extraction based on vectorized issues.

FIG. 5 shows an example dashboard that displays metrics and options for insights related to support operations.

FIG. 6 illustrates an example of clustering that may demonstrate how different categories may be organized hierarchically.

FIG. 7 shows an example of a GenAI Powered Chat Insights interface that may include features for analyzing and optimizing support agent interactions.

FIG. 8 depicts an example temporal analysis dashboard that may provide visualizations of chat data patterns over time.

FIG. 9 illustrates an example knowledge base evolution dashboard that may display metrics related to the growth and impact of a support knowledge base.

FIG. 10 shows an example AI-powered support optimization interface that may include real-time chat analysis and recommendation features.

FIG. 11 shows a diagram of an example computing system that may facilitate the performance of one or more of the methods described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

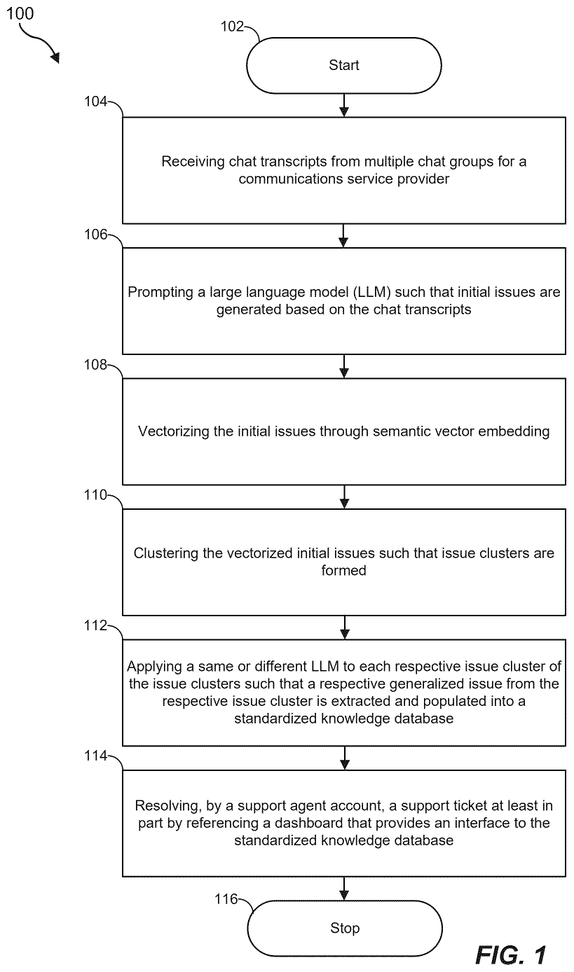

FIG. 1 shows an example flow diagram for a method 100 relating to AI-powered subscriber support. At step 102, method 100 may start. At step 104, method 100 may include receiving chat transcripts from multiple chat groups for a communications service provider where the chat transcripts may include distinct support agent accounts of the communications service provider exchanging information about support tickets issued by subscribers who may subscribe to a technological service provided by the communications service provider. At step 106, method 100 may include issuing an engineered prompt to a large language model (LLM) such that initial issues may be generated based on the chat transcripts. At step 108, method 100 may include vectorizing the initial issues through semantic vector embedding. At step 110, method 100 may include clustering the vectorized initial issues to form issue clusters. At step 112, method 100 may include applying a same or different LLM to each respective issue cluster of the issue clusters such that a respective generalized issue from the respective issue cluster may be extracted and populated into a standardized knowledge database. At step 114, method 100 may include resolving, by a support agent account, a support ticket at least in part by referencing a dashboard that may provide an interface to the standardized knowledge database. At step 116, method 100 may end.

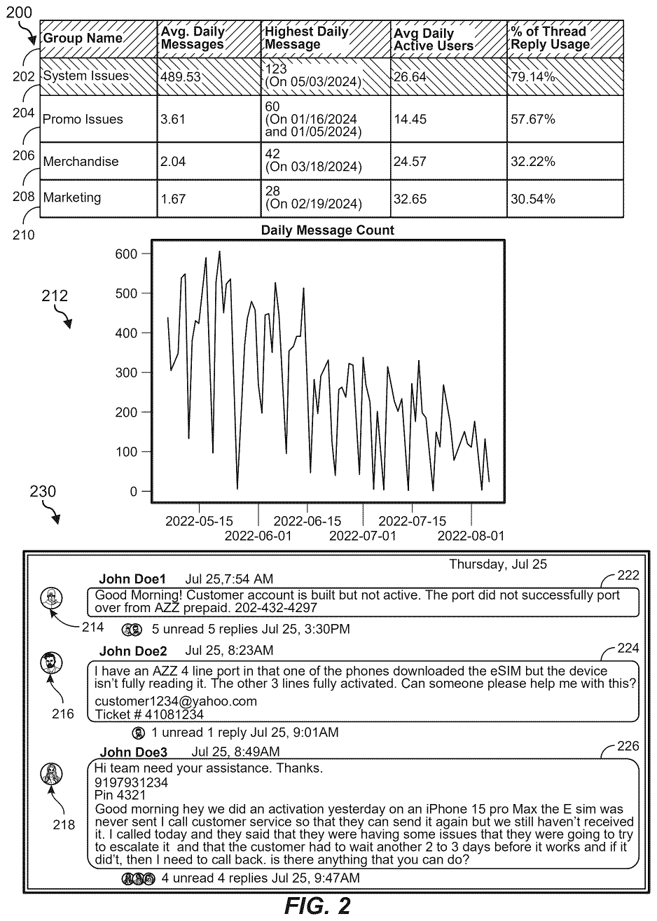

FIG. 2 shows an example dashboard that may provide insights into chat group statistics and support agent interactions. The figure is divided into three panels: a top panel 200, a mid panel 212, and a bottom panel 230, each offering distinct visualizations of support-related data that may be helpful in improving customer service operations. In some examples, these visualizations may be used to identify trends, assess performance, and/or make data-driven decisions to enhance the efficiency and effectiveness of support teams. The top panel 200 presents a chart with five columns and five rows, offering an overview of various chat group metrics that may be instrumental in understanding the dynamics of different support teams. The columns, from left to right, are labeled as group name, average daily messages, highest daily message, average daily active users, and percent of thread reply usage. Row 202 serves as a header, listing these column names, while the subsequent rows provide data for different support groups: row 204 for system issues, row 206 for promo issues, row 208 for merchandise, and row 210 for marketing. This layout may allow for quick comparisons between different support groups and their respective performance metrics, potentially highlighting areas that may benefit from additional resources or process improvements.

In some scenarios, one item of interest in the top panel 200 may be the percent of thread reply usage column, where the system issues group in row 204 shows a high value of 79.14%. This elevated percentage may suggest that the system issues group experiences a higher level of complex or ongoing conversations that benefit from threaded replies. In some scenarios, this information could be used to identify areas where more in-depth support or knowledge sharing may be beneficial. For instance, the high thread usage in the system issues group might indicate a desire for more comprehensive documentation or training materials to address recurring complex issues. Additionally, the contrast between the thread usage percentages across different groups may provide insights into the nature of issues handled by each team, potentially informing decisions about resource allocation or specialized training programs.

In some examples, the data presented in the top panel 200 may be utilized to improve support operations through a series of analytical steps and responsive actions. The process may begin by calculating the percent of thread reply usage for each support group, as shown in the rightmost column of the chart. Once these percentages are determined, they may be compared to identify groups with higher thread reply usage rates. The system issues group in row 204, with its 79.14% usage rate, may be flagged as a high-usage group in this analysis. For support groups exhibiting higher thread reply usage, additional steps may be taken to address potential underlying factors and/or improve efficiency. One primary action may involve selecting the chat transcripts from these high-usage groups for further analysis using vectorizing and clustering techniques, including method 100. Computational and/or business resources may be prioritized, ranked, and/or allocated accordingly. This selection process may help focus computational resources on the most complex or recurring issues, potentially leading to more impactful insights. In addition to this action, organizations may conduct in-depth reviews of the types of issues commonly addressed in threaded conversations within the high-usage groups. This review process may lead to the development of more comprehensive documentation and/or knowledge base articles to address frequently discussed topics. Organizations may also consider implementing targeted training programs for support agents to enhance their ability to resolve complex issues more efficiently. In some scenarios, the analysis of high-usage groups may prompt the exploration of creating specialized sub-teams to focus on particularly complex or recurring issues. These sub-teams may develop deep expertise in specific problem areas, potentially reducing the need for extended threaded conversations over time. By systematically analyzing thread reply usage data and implementing responsive measures, organizations may work towards improving the efficiency and effectiveness of their support operations. This iterative process of analysis and response may lead to continuous improvements in support quality, potentially resulting in higher customer satisfaction and more efficient use of support resources.

The mid panel 212 displays a daily message count chart, offering a visual representation of message volume trends over time. The vertical axis of this chart ranges from 0 to 600, representing the number of daily messages, while the horizontal axis spans from May 15, 2022, to Aug. 1, 2022. The line graph in this panel exhibits dramatic oscillations, occurring approximately every quarter-month. These fluctuations may correspond to various factors such as weekly cycles, promotional events, or system updates that impact customer inquiries. One trend in this chart is the overall decrease in average message height from approximately 450 on the left side to about 100 on the right side. This declining trend may indicate a reduction in support volume over time, which could be attributed to improved system stability, enhanced self-service options, and/or seasonal variations in customer behavior. In some examples, analyzing these trends may help in predicting future support volume, planning staffing levels, and/or identifying the impact of specific initiatives or events on support workload.

In the bottom panel 230, a chat transcript is presented, showcasing interactions between support agents. This panel includes messages from three different agents: John Doe1 with message 222 (corresponding to icon 214), John Doe2 with message 224 (corresponding to icon 216), and John Doe3 with message 226 (corresponding to icon 218). Each of these messages shows the initiation of a discussion or seeking assistance regarding a specific support ticket topic. As an illustrative example, message 222 from John Doe1 states: “Good Morning! Customer account is built but not active. The port did not successfully port over from AZZ prepaid. 202-432-4297”. This message illustrates one example of the types of issues that support agents may encounter and discuss among themselves, highlighting the collaborative nature of the support process. In some scenarios, analyzing these chat transcripts may provide valuable insights into common customer issues, the effectiveness of current troubleshooting processes, and/or areas where additional agent training or knowledge base improvements may be helpful. The inclusion of specific customer details in the messages may also indicate the level of information agents typically share when seeking assistance, which could inform policies on data handling and privacy in inter-agent communications.

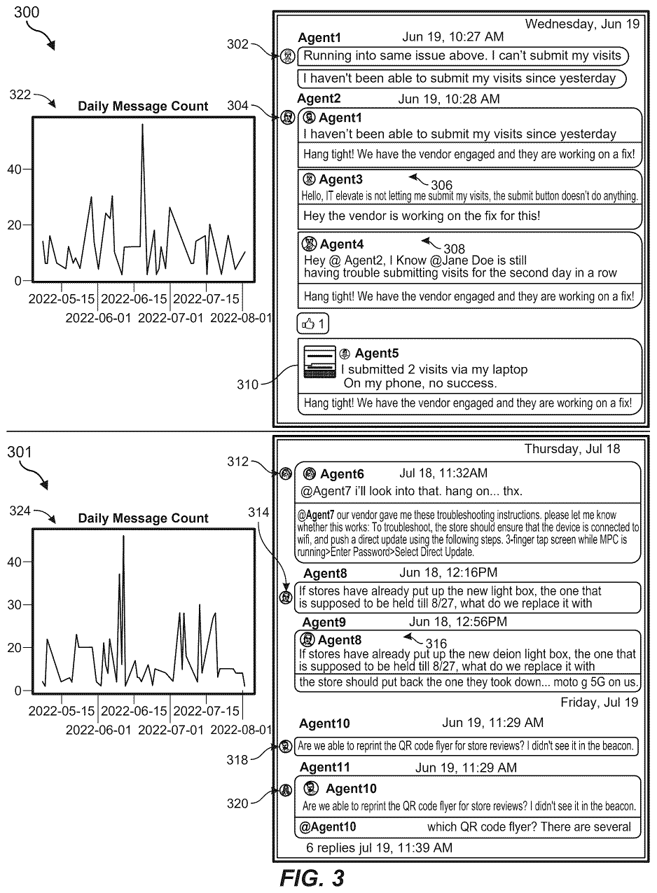

FIG. 3 shows an example visualization of support interactions across different departments, divided into a top panel 300 focused on marketing issues and a bottom panel 301 addressing merchandise concerns. Each panel presents a daily message count chart (322 for marketing and 324 for merchandise) alongside a representative chat transcript, offering insights into the volume and nature of support interactions within these distinct areas. The inclusion of both quantitative data in the form of message counts and qualitative information from chat transcripts may provide a view of the challenges faced by different support teams. This combination of data types may allow for a more nuanced understanding of the issues affecting each department, potentially leading to more targeted and effective solutions.

In the top panel 300, the chat transcript reveals a recurring issue affecting multiple agents' ability to submit visits. Agent1 302 expresses frustration, stating, “Running into same issue above. I can't submit my visits” and “I haven't been able to submit my visits since yesterday.” This message suggests an ongoing problem that may be impacting the team's productivity. Agent2 304 responds with, “Hang tight! We have the vendor engaged and they are working on a fix!” This response, which is repeated throughout the transcript, indicates that the issue may have been escalated to an external vendor for resolution. The repetition of this message by Agent2 304 may imply that the problem is persisting and affecting multiple team members, necessitating frequent updates. Later in the conversation, Agent5 310 adds, “I submitted 2 visits via my laptop” and “On my phone, no success.” This message provides additional context, suggesting that the issue may be platform-specific, affecting mobile submissions while desktop submissions may remain partially functional. The recurring nature of the problem and the involvement of an external vendor may highlight the complexity of the issue and its potential impact on the marketing team's operations. In some scenarios, this type of persistent issue may lead to increased thread reply usage as agents continue to discuss and troubleshoot the problem over an extended period.

The bottom panel 301 showcases a different set of challenges faced by the merchandise support team. Agent6 312 initiates a conversation with, “@Agent7 i'll look into that. hang on . . . thx.” This message suggests a collaborative technique to problem-solving within the team. Agent8 314 raises a specific concern about store displays: “If stores have already put up the new light box, the one that is supposed to be held till 8/27, what do we replace it with.” This query indicates potential issues with the timing of marketing material deployments and the desire for clear communication regarding display changes. Agents 318 and 320 both ask, “Are we able to reprint the QR code flyer for store reviews? I didn't see it in the beacon.” The repetition of this question by multiple agents may suggest a widespread desire for access to specific marketing materials or a potential gap in the distribution of information about available resources. These interactions demonstrate the variety of issues that may arise in merchandise support, ranging from logistical concerns about display materials to questions about the availability of marketing collateral.

In some examples, these chat transcripts may be relevant to the method of improving support operations through AI-powered analysis. The higher percentage of thread reply usage observed in certain groups, as discussed in relation to FIG. 2, may be reflected in the nature of the conversations shown in FIG. 3. For instance, the ongoing issue with visit submissions in the marketing panel may lead to extended threaded conversations as agents provide updates and troubleshoot the problem. Similarly, the questions about marketing materials in the merchandise panel may result in threaded discussions as agents seek clarification and solutions. These types of recurring or complex issues may be prime candidates for the vectorizing and clustering process described in method 100. By applying natural language processing and machine learning techniques to these chat transcripts, the system may identify common themes, recurring problems, and potential knowledge gaps. This analysis may then inform the creation of more comprehensive documentation, targeted training programs, and/or improvements to internal communication processes. More specifically, analysis indicating a higher percentage of thread replies may form the basis for prioritization of computing resources for performing method 100 including the vectorizing and clustering processes, etc. Additionally, the system may use the insights gained from these transcripts to predict future support needs and proactively address potential issues before they escalate. The combination of quantitative data from message counts and qualitative data from chat transcripts may provide a rich dataset for the AI-powered system to analyze, potentially leading to more nuanced and effective improvements in support operations across different departments.

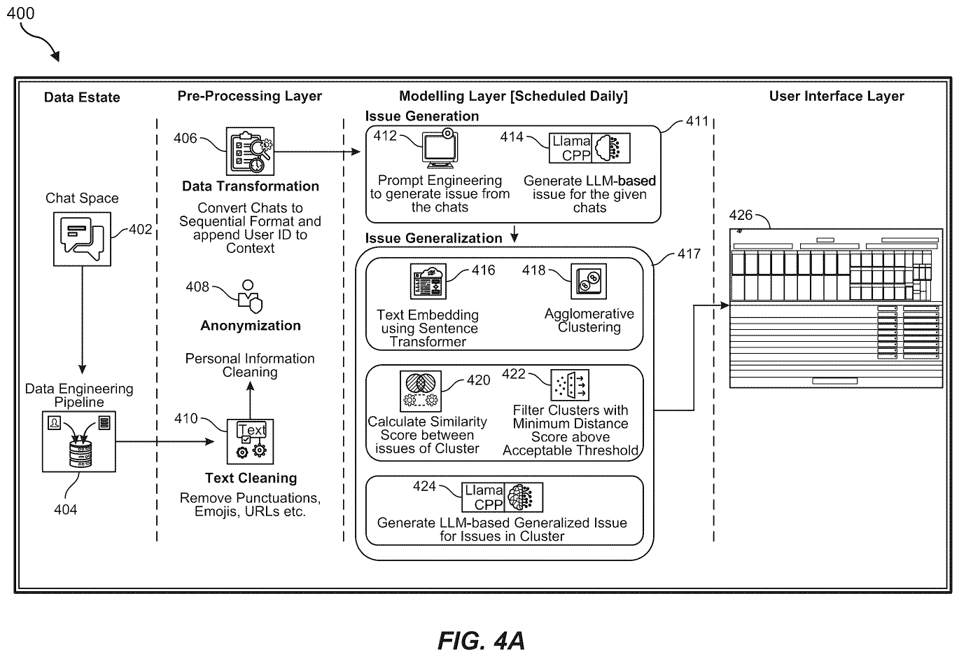

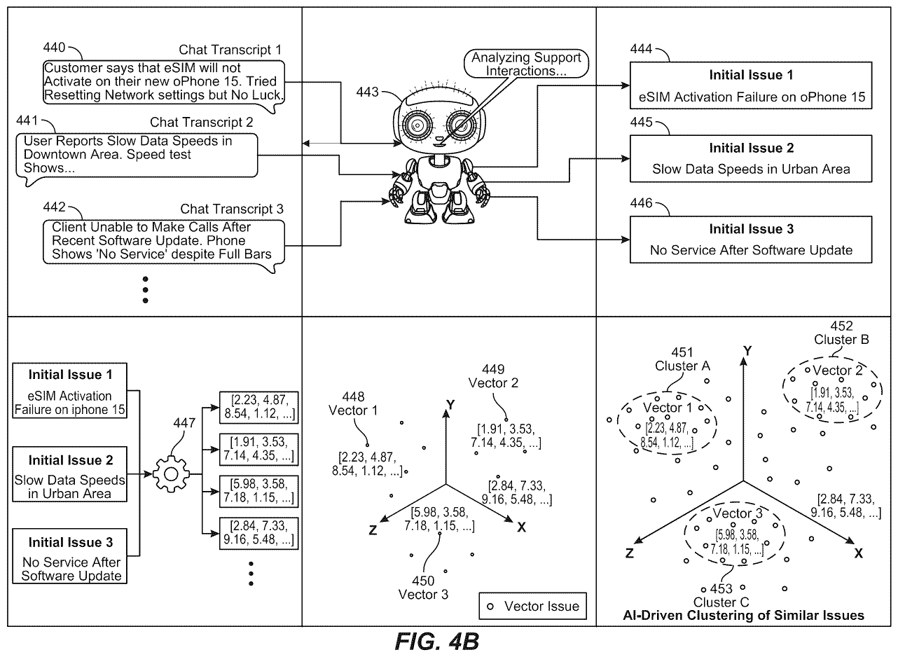

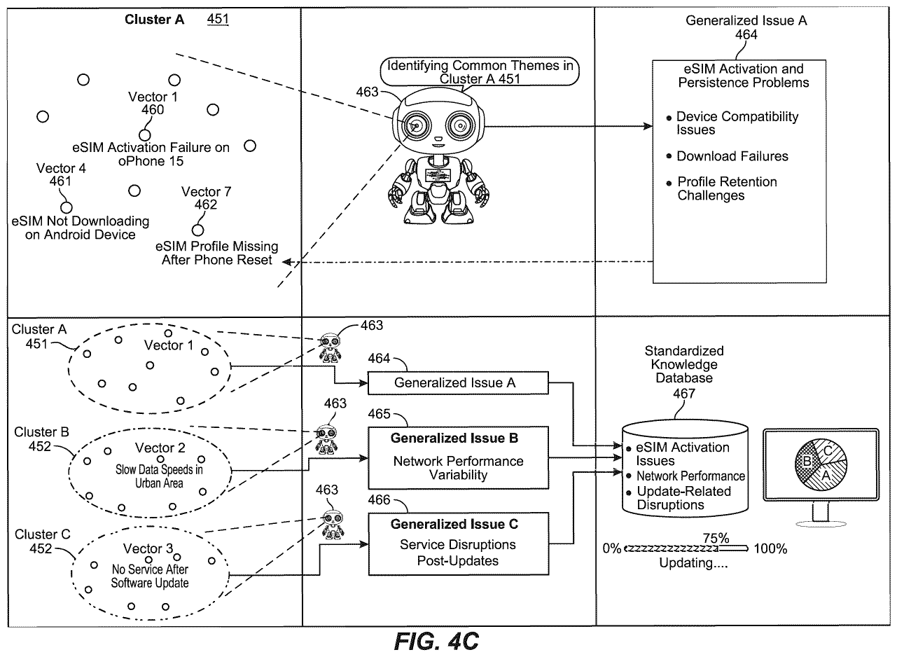

FIG. 4A shows an example architecture diagram 400 illustrating the flow of data and processing steps in an AI-powered support analysis system. The figure is divided into four main columns, representing different stages of the process: data estate, pre-processing layer, modeling layer (e.g., scheduled daily), and user interface layer. The overall flow of information generally progresses from left to right, with some vertical movements within columns. This architecture may provide a comprehensive view of how support chat data may be collected, processed, analyzed, and/or ultimately presented to users for improved decision-making and support operations. In some scenarios, this system may be implemented as a scalable, cloud-based solution that may handle large volumes of chat data from multiple support teams and/or departments.

In the leftmost column, the data estate is depicted. This section includes two main components: a chat space 402 and a data engineering pipeline 404. An arrow connects chat space 402 to data engineering pipeline 404, indicating that data may flow from the former to the latter. The chat space 402 may serve as a repository for all support-related chat conversations, potentially including both agent-to-agent and/or agent-to-customer interactions. This centralized storage may allow for comprehensive analysis of support trends and issues across different teams and/or time periods. The data engineering pipeline 404 may be responsible for extracting, transforming, and/or loading the chat data into a format suitable for further processing. In some examples, this pipeline may include tasks such as data validation, deduplication, and/or initial formatting to ensure consistency across various chat sources.

Moving to the second column, the pre-processing layer is shown with three main components: data transformation 406, anonymization 408, and text cleaning 410. An arrow connects text cleaning 410 to anonymization 408, suggesting that the text cleaning process may occur before or in conjunction with anonymization. Another arrow leads from data transformation 406 to the next column, indicating that the transformed data may flow into the modeling layer. The data transformation 406 may include converting chats to a sequential format and appending user IDs to provide context. This transformation may be helpful in preserving the temporal nature of conversations and/or associating messages with specific users for more accurate analysis. Anonymization 408 may focus on personal information cleaning, potentially removing or obscuring sensitive data to comply with privacy regulations and/or internal policies. Text cleaning 410 may involve removing punctuations, images, URLs, and other elements that may not be relevant for the analysis. This cleaning step may help in standardizing the text data and reducing noise that could otherwise impact the accuracy of subsequent modeling steps.

The third column represents the modeling layer, which may be scheduled to run daily or according to any suitable periodic or other schedule (weekly, etc.). This layer may include two main components: issue generation 411 and issue generalization 417. Issue generation 411 includes two sub-steps: prompt engineering to generate issues from the chats 412 and generating LLM-based issues for the given chats 414. These steps may leverage advanced natural language processing techniques to identify and categorize the main issues or topics discussed in the support conversations. The issue generalization component 417 includes several sub-steps grouped into two boxes. The first box contains text embedding using sentence transformer 416 and agglomerative clustering 418. These techniques may be used to convert the identified issues into numerical representations and group similar issues together. The second box includes calculating similarity scores between issues of clusters 420 and filtering clusters with minimum distance scores above an acceptable threshold 422. These steps may help in refining the clusters and ensuring that only sufficiently similar issues are grouped together. Finally, the system may generate LLM-based generalized issues for the issues and clusters 424. This step may produce higher-level categorizations or summaries of the identified issues, potentially making it easier for support teams to understand and address recurring problems.

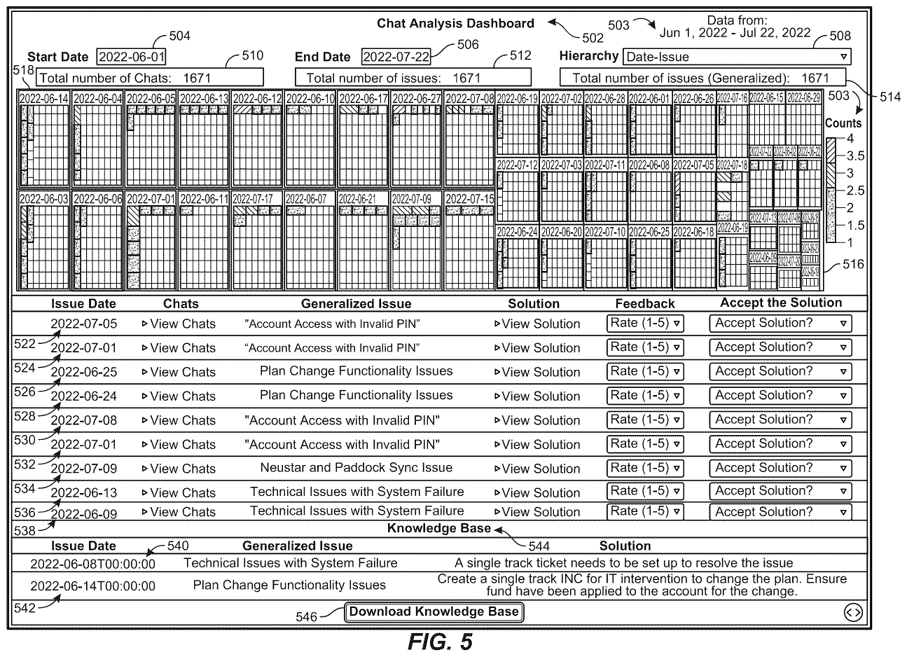

The rightmost column shows the user interface layer, represented by a miniature icon version of the dashboard 426. This dashboard may correspond to a more detailed view shown later in FIG. 5. The presence of this dashboard in the architecture diagram suggests that the processed and analyzed data may be presented in a user-friendly format, allowing support teams and/or managers to gain insights from the AI-powered analysis. In some examples, this dashboard may include interactive elements that allow users to drill down into specific issues, view trends over time, and/or generate reports based on the analyzed data. The flow of information from the modeling layer to the user interface layer, as indicated by the arrow, may ensure that the insights generated by the AI system are readily available to those who may benefit from them in improving support operations.

In some examples, the process of converting chat transcripts to a sequential format and/or appending user IDs to provide context may involve various techniques and/or considerations. The conversion to a sequential format may be achieved through multiple methods, such as chronological ordering based on timestamp information, thread-based sequencing that groups related messages together, or a combination of both techniques. In some scenarios, the system may employ natural language processing algorithms to identify and link semantically related messages, even if they are not explicitly threaded. The sequential format may also incorporate visual cues or formatting elements to delineate different speakers or conversation threads, potentially improving readability and analysis. When appending user IDs to provide context, the system may utilize various identification methods, such as unique numerical identifiers, hashed usernames, or role-based tags (e.g., “Agent1”, “Customer2”). These IDs may be integrated into the sequential format in different ways, such as prefixing each message with the corresponding ID, creating a separate metadata field for user information, or embedding the ID within the message content itself. In some implementations, the system may maintain a separate lookup table that maps anonymized IDs to more detailed user profiles, allowing for privacy-preserving analysis while retaining the ability to derive insights based on user characteristics or history. The process of converting chats to sequential format and appending user IDs may also involve data cleaning and normalization steps, such as standardizing date and time formats, removing irrelevant system messages or automated notifications, and handling edge cases like deleted messages or user name changes mid-conversation. Additionally, the system may apply sentiment analysis or topic modeling techniques to each sequentially formatted message, potentially enhancing the context provided by user IDs with emotional or thematic information. In some examples, the conversion process may include the extraction and standardization of any structured data embedded within the chat messages, such as order numbers, product codes, or ticket IDs, which may be appended as additional context alongside the user IDs. The system may also consider the handling of multi-modal conversations that include images, files, or links, potentially converting these elements into text descriptions or metadata that can be incorporated into the sequential format. Furthermore, the conversion process may account for different chat platforms or messaging systems, each with its own data structure and formatting quirks, by implementing platform-specific adapters or converters to ensure consistency in the final sequential format. In scenarios involving long-running or multi-session conversations, the system may implement techniques for session stitching, allowing for the creation of a cohesive sequential narrative that spans multiple interactions over time while maintaining appropriate user ID context throughout.

In some examples, the process of text cleaning may involve various techniques to remove and/or transform elements such as punctuation, emojis, URLs, and/or other extraneous content from chat transcripts or support messages. This cleaning process may be helpful in preparing the text for further analysis and/or processing by natural language models. One technique for text cleaning may involve the use of regular expressions to identify and/or remove specific patterns of characters, such as URLs, email addresses, and/or phone numbers. Additionally, the system may employ character set filtering to eliminate non-alphanumeric characters, potentially preserving spaces to maintain word boundaries. In some scenarios, the text cleaning process may include the conversion of all text to lowercase or uppercase to standardize the input for subsequent analysis. The handling of emojis and/or other Unicode characters may vary depending on the specific requirements of the analysis. In some cases, emojis may be removed entirely, while in others, they may be replaced with textual descriptions or sentiment indicators to preserve the emotional context of the message. For URLs, the system may choose to either remove them completely, replace them with placeholder text (e.g., “[URL]”), and/or extract and retain only the domain name for reference. Punctuation handling may also differ based on the intended use of the cleaned text. Some approaches may remove all punctuation, while others may selectively retain certain marks, such as periods or question marks, to preserve sentence boundaries and/or question-answer pairs. In cases where the cleaned text may be used for sentiment analysis or topic modeling, preserving certain punctuation marks like exclamation points or question marks may be helpful. The text cleaning process may also address issues such as repeated characters (e.g., “hellooooo” to “hello”) and/or the expansion of common abbreviations and/or contractions. In some implementations, the system may employ language-specific rules and/or dictionaries to handle idiomatic expressions and/or colloquialisms that may not be easily cleaned using generic rules. The treatment of numeric data within the text may vary, with some approaches preserving all numbers, others removing them entirely, and/or some selectively retaining numbers based on context (e.g., keeping product codes but removing arbitrary digits). Whitespace normalization may be another aspect of text cleaning, potentially condensing multiple spaces, tabs, and/or line breaks into single spaces to create a more uniform text structure. In scenarios involving multi-language support, the text cleaning process may include language detection steps to apply appropriate cleaning rules based on the detected language. Furthermore, the system may implement techniques to handle code snippets and/or technical jargon often found in support conversations, potentially preserving these elements with special tags and/or applying domain-specific cleaning rules. The text cleaning process may also consider the handling of personally identifiable information (PII), implementing anonymization techniques to replace sensitive data with placeholders while maintaining the overall context of the message. In some examples, the text cleaning may be adaptive, learning from feedback and/or downstream analysis results to refine its rules and/or techniques over time, potentially improving the quality and/or relevance of the cleaned text for specific analysis tasks.

In some examples, the process of removing personally identifiable information (PII) from chat transcripts and/or support messages may involve various techniques to protect user privacy while maintaining the context and usefulness of the data for analysis. In some examples, PII may include and/or encompass a user's name, address, phone number, email address, social security number, driver's license number, passport number, credit card information, bank account details, date of birth, biometric data (such as fingerprints and/or facial recognition data), IP address, device identifiers, geolocation data, medical records, educational records, employment history, social media profiles, and/or any combination of information that may be used to identify, contact, and/or locate a specific individual. The system may employ named entity recognition algorithms to identify and redact specific types of PII, such as names, addresses, phone numbers, and/or email addresses. In some scenarios, the identified PII may be replaced with generic placeholders (e.g., “[NAME]”, “[ADDRESS]”) or anonymized identifiers (e.g., “Person1”, “Address2”) to preserve the structure of the text while removing sensitive information. The system may also utilize pattern matching and/or regular expressions to detect and remove less structured PII, such as credit card numbers or social security numbers. In some implementations, the PII removal process may incorporate domain-specific knowledge to identify and redact industry-specific identifiers or sensitive information unique to particular business contexts. The system may also employ machine learning models trained on annotated datasets to recognize and remove PII in various formats and languages, potentially adapting to new patterns of PII as they emerge. Additionally, the PII removal process may include techniques for handling indirect identifiers or quasi-identifiers that, when combined, could potentially reveal an individual's identity. This may involve techniques such as k-anonymity or differential privacy to further protect user privacy in aggregate data analysis.

In some examples, prompt engineering for generating issues from chats may involve various techniques to improve the input provided to large language models (LLMs). The process may include crafting specific instructions and/or context that guide the LLM in extracting relevant information from chat transcripts. Prompt engineering techniques may incorporate domain-specific knowledge, such as common support issues and/or industry terminology, to improve the accuracy and/or relevance of the generated issues. In some scenarios, the prompts may be structured as questions or directives, encouraging the LLM to focus on particular aspects of the chat content. The system may also employ few-shot learning techniques, where example pairs of chat snippets and corresponding issues are provided as part of the prompt to demonstrate the desired output format and/or level of abstraction. Additionally, prompt engineering may involve iterative refinement based on the quality of the LLM's outputs, potentially incorporating feedback loops and/or automated evaluation metrics to continuously improve prompt effectiveness. In some implementations, the prompts may be dynamically generated based on the specific characteristics of each chat transcript, potentially adapting to different conversation styles and/or support contexts.

In some examples, the process of text embedding using sentence transformer 416 and/or agglomerative clustering 418 may involve a series of steps to convert textual data into numerical representations and/or group similar items together. The text embedding technique may utilize various types of sentence transformers, such as BERT, RoBERTa, and/or XLNet, to generate high-dimensional vector representations of the input text. These embeddings may capture semantic meanings and/or contextual information, potentially allowing for more nuanced comparisons between different pieces of text. The sentence transformer may be pre-trained on large corpora of text and/or fine-tuned on domain-specific data to improve its performance on the particular task at hand. In some scenarios, the embedding process may incorporate techniques such as token-level attention mechanisms and/or pooling strategies to generate fixed-length vector representations from variable-length input sequences. The resulting embeddings may be further processed using dimensionality reduction techniques, such as Principal Component Analysis (PCA) and/or t-SNE, to reduce computational complexity while preserving relevant information. Once the text data has been embedded, the agglomerative clustering algorithm may be applied to group similar items together. This clustering technique may start with each data point as its own cluster and/or iteratively merge the closest clusters based on a chosen distance metric. Various distance measures may be employed, including Euclidean distance, cosine similarity, and/or Manhattan distance, depending on the nature of the data and/or the specific requirements of the application. The clustering process may utilize different linkage criteria, such as single linkage, complete linkage, and/or Ward's method, to determine the distance between clusters. In some implementations, the number of clusters may be determined dynamically using techniques like the elbow method, silhouette analysis, and/or gap statistics. Alternatively, a predefined number of clusters may be specified based on domain knowledge and/or application requirements. The agglomerative clustering process may generate a hierarchical structure of clusters, potentially allowing for multi-level analysis of the data. In some examples, the clustering results may be visualized using dendrograms and/or heatmaps to provide insights into the relationships between different data points. The combination of text embedding and/or agglomerative clustering may be applied iteratively, with the results of one iteration informing the parameters and/or techniques used in subsequent iterations, potentially leading to more refined and/or accurate clustering outcomes.

In some examples, agglomerative clustering may be employed as a technique for grouping similar issues or data points together. However, various alternative clustering methods may be utilized in place of or in conjunction with agglomerative clustering. These alternatives may include k-means clustering, which partitions the data into a predetermined number of clusters based on centroids, and/or DBSCAN (Density-Based Spatial Clustering of Applications with Noise), which groups together points that are closely packed together while marking outliers as noise. Hierarchical divisive clustering, which starts with all data points in one cluster and recursively splits them, may also be used as an alternative to agglomerative methods. In some scenarios, fuzzy clustering techniques such as fuzzy c-means may be employed, allowing data points to belong to multiple clusters with varying degrees of membership. Spectral clustering, which leverages the eigenvalues of the similarity matrix to perform dimensionality reduction before clustering, may be another viable alternative. Additionally, probabilistic clustering methods like Gaussian Mixture Models may be used to model the data as a mixture of Gaussian distributions. In some implementations, hybrid techniques that combine multiple clustering algorithms may be employed to leverage the strengths of different methods and/or improve overall clustering performance.

In some examples, calculating similarity scores between issues of clusters 420 and/or filtering clusters with minimum distance scores above an acceptable threshold 422 may involve various techniques to refine and/or validate the clustering results. The similarity scores may be computed using metrics such as cosine similarity, Jaccard index, and/or Euclidean distance, depending on the nature of the data and/or the specifics of the application. These scores may be calculated between individual issues within clusters and/or between cluster centroids to assess both intra-cluster cohesion and/or inter-cluster separation. The filtering process may employ dynamic thresholding techniques, where the acceptable threshold may be adjusted based on the distribution of similarity scores across all clusters. In some scenarios, the system may use a sliding window technique to calculate similarity scores, allowing for the detection of temporal patterns in issue similarity. For instance, the system may identify that certain issues become more similar during specific time periods, such as after software updates or during promotional events. In another example, the filtering process may incorporate a multi-level thresholding technique, where different thresholds are applied to different types of issues or clusters, potentially allowing for more nuanced control over the final cluster composition.

In some examples, agglomerative clustering may be employed as a technique for grouping similar issues or data points together. However, various alternative clustering methods may be utilized in place of or in conjunction with agglomerative clustering. These alternatives may include k-means clustering, which partitions the data into a predetermined number of clusters based on centroids, and/or DBSCAN (Density-Based Spatial Clustering of Applications with Noise), which groups together points that are closely packed together while marking outliers as noise. Hierarchical divisive clustering, which starts with all data points in one cluster and recursively splits them, may also be used as an alternative to agglomerative methods. In some scenarios, fuzzy clustering techniques such as fuzzy c-means may be employed, allowing data points to belong to multiple clusters with varying degrees of membership. Spectral clustering, which leverages the eigenvalues of the similarity matrix to perform dimensionality reduction before clustering, may be another viable alternative. Additionally, probabilistic clustering methods like Gaussian Mixture Models may be used to model the data as a mixture of Gaussian distributions. In some implementations, hybrid techniques that combine multiple clustering algorithms may be employed to leverage the strengths of different methods and/or improve overall clustering performance.

FIG. 4B shows an example process of AI-powered issue extraction and/or vectorization from chat transcripts. The figure is divided into six panels, each illustrating a different stage of the process. This multi-step visualization may provide insights into how unstructured text data from support interactions may be transformed into structured, machine-readable formats for further analysis and/or clustering. In some examples, this process may be helpful in identifying recurring patterns, prioritizing issues, and/or generating actionable insights from large volumes of customer support data.

In the top-left panel, three chat transcript snippets are displayed in chat boxes, labeled Chat Transcript 1 440, Chat Transcript 2 441, and Chat Transcript 3 442. Chat Transcript 1 440 states: “Customer says that eSIM will not activate on their new oPhone 15. Tried resetting network settings but no luck.” Chat Transcript 2 441 reads: “User reports slow data speeds in downtown area. Speed test shows 1.5 Mbps download.” Chat Transcript 3 442 contains: “Client unable to make calls after recent software update. Phone shows ‘No Service’ despite full bars.” Below these chat boxes, a series of small circles extending off the panel indicate that these are samples from a larger dataset. This visualization technique may help convey the scale of data being processed and/or the potential for identifying patterns across numerous support interactions. The diversity of issues represented in these sample transcripts may illustrate the wide range of customer problems that support systems may desire to address. In some scenarios, the ability to efficiently process and/or categorize such varied inputs may be helpful in improving response times, identifying trends, and/or developing more comprehensive support strategies.

The top-middle panel depicts the AI processing of chat transcripts. A large, stylized AI robot 443 is shown in the center, with arrows coming from each chat transcript in the previous panel to the AI robot 443. A speech bubble near the AI robot 443 contains the text: “Analyzing support interactions . . . ” This representation illustrates how the AI system ingests and/or processes the unstructured text data from support chats. In some examples, this AI processing stage may involve techniques such as natural language processing, sentiment analysis, and/or entity recognition to extract relevant information from the chat transcripts, as discussed above. The centralized nature of the AI robot 443 in this panel may suggest the system's ability to consolidate and/or analyze inputs from multiple sources simultaneously, potentially enabling more efficient and/or comprehensive issue identification.

The top-right panel shows the initial issues extraction. Three boxes labeled Initial Issue 1 444, Initial Issue 2 445, and/or Initial Issue 3 446 are displayed. Initial Issue 1 444 contains: “eSIM activation failure on oPhone 15”. Initial Issue 2 445 states: “Slow data speeds in urban area”. Initial Issue 3 446 reads: “No service after software update”. Arrows from the AI robot 443 in the previous panel to each of these Initial Issue boxes may indicate the AI system's output. This stage may represent how the AI system distills the problems from the chat transcripts, potentially reducing noise and/or identifying the core issues that may merit attention. The ability to extract concise, standardized issue descriptions from varied and/or verbose customer reports may be helpful in several ways. It may facilitate quicker issue categorization, enable more accurate routing of support tickets, and/or provide a foundation for identifying recurring problems across multiple customer interactions. In some scenarios, this standardization process may also contribute to more consistent support responses and/or help in building a more structured knowledge base for future reference.

The bottom-left panel illustrates the vectorization process. The three Initial Issue boxes from the previous panel are shown on the left side. A Vectorization Engine 447, represented as a gear icon, is shown in the center. Arrows from each Initial Issue box enter the Vectorization Engine 447. On the right side of the Vectorization Engine 447, three vector representations emerge, each represented as a series of numbers (e.g., [0.78, 0.23, 0.56, 0.91, . . . ]). This visualization depicts how textual descriptions of issues are converted into numerical representations that may be more easily processed by machine learning algorithms. The vectorization process may be a helpful step in enabling more sophisticated analysis and/or clustering of support issues. In some examples, this transformation may allow for quantitative comparisons between different issues, potentially revealing similarities or patterns that may not be immediately apparent from the text alone. The output vectors, represented as series of numbers, may encode various features of the issues, such as topic, severity, and/or frequency, in a format that may be more conducive to computational analysis.

The bottom-middle panel shows a vector representation in a 3D coordinate system with labeled X, Y, and/or Z axes. The three vectors from the previous panel are plotted as points in this 3D space, labeled Vector 1 448, Vector 2 449, and/or Vector 3 450. Many more unlabeled points are scattered throughout the space to represent other vectors. A legend explaining that each point represents a vectorized issue is included. This 3D representation may help illustrate how issues may be compared and/or grouped based on their proximity in the vector space. The use of a three-dimensional visualization may suggest the complexity of the relationships between different issues, where similarity may be determined by multiple factors simultaneously. Nevertheless, in some practical examples, the vectors may have a much larger number of dimensions, as understood by those having skill in the art. In some scenarios, this spatial representation may enable support teams to identify clusters of related issues more easily, potentially leading to more efficient problem-solving strategies and/or resource allocation. The inclusion of many unlabeled points in addition to the three labeled vectors indicates the scalability of this technique, suggesting that it may be applied to large datasets comprising numerous customer support interactions.

The bottom-right panel depicts the initial clustering of the vectorized issues. Using the same 3D space from the previous panel, but zoomed out to show more points, this visualization includes light, transparent spheres or boundaries around groups of points, indicating at least three distinct clusters. These clusters are labeled Cluster A 451, Cluster B 452, and/or Cluster C 453. Vectors 1, 2, and/or 3 from the previous panel are visible and part of these clusters. An annotation stating “AI-driven clustering of similar issues” is shown. This clustering visualization may illustrate how the AI system groups similar issues based on their vector representations, potentially revealing patterns or trends in customer support data. The formation of distinct clusters may help in identifying common themes or recurring problems across multiple customer interactions. In some examples, this clustering technique may be helpful for various support-related tasks, such as prioritizing widespread issues, developing targeted solutions for specific problem categories, and/or allocating resources more effectively based on the volume and/or nature of issues in each cluster. The transparent nature of the cluster boundaries may suggest the potential for issues to belong to multiple clusters or for cluster definitions to evolve over time as more data is processed. This flexibility may be helpful in capturing the nuanced relationships between different types of customer issues and/or adapting to changing support trends.

FIG. 4C shows an example of cluster analysis and/or generalized issue extraction based on vectorized issues. The figure is divided into six panels, each illustrating a different stage of the process. This multi-step visualization may provide insights into how AI systems may analyze and/or categorize support issues to generate more generalized problem descriptions and/or populate a standardized knowledge database. The technique depicted in this figure may be helpful in transforming large volumes of specific customer complaints into more manageable and/or actionable categories, potentially improving the efficiency and/or effectiveness of support operations.

The top-left panel presents a close-up view of Cluster A 451 from FIG. 4B. Within this cluster, at least seven vector points are shown, with three of these points labeled as Vector 1 460, Vector 4 461, and/or Vector 7 462. These vectors correspond to the vectorized initial issues shown in Cluster A 451 in FIG. 4B. Next to Vector 1 460, the corresponding initial issue is written: “eSIM activation failure on iPhone 15”, which is the same as Initial Issue 1 444 from FIG. 4B. Vector 4 461 is associated with a new issue not shown in FIG. 4B: “eSIM not downloading on Android device”. Similarly, Vector 7 462 corresponds to another new issue: “eSIM profile missing after phone reset”. These new issues may be the result of the first LLM process depicted in FIG. 4B's top-middle panel, applied to additional chat transcripts. This detailed view of a single cluster may illustrate how multiple, related issues may be grouped together based on their vector representations, as shown in the clustering process of FIG. 4B's bottom-right panel. The inclusion of specific issue descriptions for each labeled vector may help in understanding the types of problems that may be considered similar by the AI system. In some examples, this clustering technique may be helpful in identifying common themes and/or underlying causes across seemingly distinct customer complaints. The variety of devices and/or specific problems within the same cluster may suggest that the AI system may be capable of recognizing similarities in issues beyond surface-level descriptions, potentially leading to more comprehensive problem-solving techniques and/or knowledge base entries. Additionally, this visualization may provide insights into how the AI system may handle nuanced differences within a broader category of issues, potentially enabling more targeted and/or effective support strategies.

The top-middle panel depicts an AI robot 463 analyzing the cluster from the previous panel. The AI robot 463 has a “scanning” beam emanating from its eyes, covering the cluster. A thought bubble near the AI robot 463 contains the text: “Identifying common themes in cluster A 451 . . . ” This visualization represents the AI system's process of examining the clustered issues to identify overarching themes and/or common factors. The scanning beam may suggest a thorough and/or systematic analysis of all points within the cluster. In some scenarios, this analysis step may be helpful in distilling large volumes of specific customer complaints into more manageable and/or actionable categories. The thought bubble text may indicate the AI system's ability to recognize that the issues in this cluster are all related to eSIM technology, despite the varying specifics of each problem. This level of abstraction may be helpful for support teams in developing more comprehensive solutions and/or troubleshooting guides that address a wider range of related issues.

The top-right panel shows the generalized issue extraction process. An arrow leads from the AI robot 463 to a new box labeled Generalized Issue A 464. Inside the Generalized Issue A 464 box, the text reads: “eSIM Activation and Persistence Problems”. Below this, a bullet point list includes: “Device compatibility issues”, “Download failures”, and/or “Profile retention challenges”. A dotted line connects this box back to Cluster A 451, showing the relationship between the specific issues and/or the generalized problem description. This panel illustrates how the AI system may synthesize information from multiple related issues to create a more comprehensive problem description. The generalized issue may encompass the common themes identified across all the specific problems within the cluster. In some examples, this abstraction process may be helpful in creating more versatile knowledge base entries that may address a wider range of customer issues. The bullet points under the generalized issue may provide a structured breakdown of the main sub-categories within the broader problem, potentially aiding support agents in quickly identifying the specific aspect of the issue that may be most relevant to a given customer's complaint. This structured approach to summarizing complex issues may also facilitate more efficient knowledge sharing among support team members and/or enable more targeted training programs for new support agents.

In some examples, the process illustrated across FIG. 4B and FIG. 4C may represent a two-stage Large Language Model (LLM) summarization and/or synthesizing technique. This two-stage process may leverage the capabilities of LLMs to generate increasingly abstracted and/or generalized representations of support issues. In the first stage, as depicted in FIG. 4B, an LLM may be applied to raw chat transcript text to generate initial issues. These initial issues may then be vectorized and/or clustered based on their semantic similarities. In the second stage, shown in FIG. 4C, the same LLM and/or a different LLM may be applied to the clusters of initial issues generated in the first stage. This second-stage LLM may primarily operate on the text labels (i.e., the initial issues) that were generated by the first-stage LLM in FIG. 4B. However, the second-stage LLM may also incorporate the vector representations associated with each initial issue in its analysis. To facilitate this process, each numerical vector may be tied and/or associated, as a data structure, with its corresponding LLM-generated initial issue from FIG. 4B. This association may enable the second-stage LLM to extract generalized issues by analyzing both the textual content of the initial issues and/or the mathematical relationships represented by their associated vectors. The two-stage technique may allow for a progressive refinement of issue categorization, potentially leading to more nuanced and/or comprehensive generalized issue descriptions. By working in two distinct stages, with the second stage building upon the outputs of the first, this process may leverage the strengths of LLMs in natural language understanding and/or generation at multiple levels of abstraction.

The bottom-left panel illustrates a multiple cluster analysis, showing three distinct clusters from FIG. 4B's bottom-right panel: Cluster A 451, Cluster B 452, and Cluster C 453. Each cluster contains multiple vector points, with one labeled point per cluster. In Cluster B 452, one point is labeled Vector 2 and has the nearby text: “Slow data speeds in urban area”. In Cluster C 453, a point is labeled Vector 3 and/or has the nearby text: “No service after software update”. This visualization may demonstrate how the AI system may handle multiple categories of issues simultaneously, potentially enabling a more comprehensive analysis of support trends and/or patterns. The inclusion of specific issue descriptions for each labeled vector across different clusters may illustrate the diversity of problems that the system may be capable of categorizing and/or analyzing. In some scenarios, this multi-cluster analysis may be helpful in identifying relationships between seemingly unrelated issues, potentially leading to more holistic solutions and/or support strategies. The spatial arrangement of the clusters may also provide insights into the relative similarities and/or differences between various categories of support issues, which may be valuable for prioritizing resources and/or developing targeted improvement initiatives.

The bottom-middle panel focuses on generating generalized issues for multiple clusters. Three boxes labeled Generalized Issue A 464, Generalized Issue B 465, and/or Generalized Issue C 466 are shown. The Generalized Issue B 465 box contains the text: “Network Performance Variability”, while the Generalized Issue C 466 box states: “Service Disruptions Post-Updates”. Arrows are drawn from each cluster in the previous panel to its corresponding Generalized Issue box. The AI robot 463 is positioned between the clusters and/or boxes, with scanning beams touching all elements, suggesting it is processing everything simultaneously. This panel illustrates how the AI system may generate higher-level categorizations for multiple clusters of issues. The generalized issues represent broader themes that encompass various specific problems within each cluster. In some examples, this multi-cluster generalization process may be helpful in identifying overarching patterns across different types of support issues, potentially enabling more strategic decision-making and/or resource allocation. The presence of the AI robot 463 scanning all elements may suggest the system's ability to consider complex relationships between different issue categories, potentially leading to more nuanced and/or comprehensive support strategies.

The bottom-right panel depicts the process of populating a standardized knowledge database. A large database icon and/or server rack labeled Standardized Knowledge Database 467 is shown. Arrows flow from the three Generalized Issue boxes (464, 465, 466) into the database. On the database, truncated versions of the three generalized issues are listed: “eSIM Activation Issues”, “Network Performance”, and/or “Update-Related Disruptions”. An “Updating . . . ” progress bar at 75% completion is displayed below the database. A small screen and/or monitor next to the database shows a pie chart with three slices labeled “A”, “B”, and/or “C” to represent the distribution of the generalized issues. This panel illustrates how the AI-generated insights are integrated into a centralized knowledge repository. The flow of information from generalized issues to the database represents the process of creating standardized, easily accessible support resources. In some scenarios, this automated knowledge base population may be helpful in maintaining an up-to-date and/or comprehensive support resource, potentially improving the consistency and/or efficiency of customer support efforts. The progress bar and/or pie chart may provide visual feedback on the status and/or composition of the knowledge base, which may be valuable for monitoring and/or managing the knowledge creation process. The structured nature of the database entries may facilitate easier searching and/or retrieval of relevant information by support agents, potentially leading to faster problem resolution and/or improved customer satisfaction.

FIG. 5 shows an example of a Chat Analysis Dashboard 502 that may provide a comprehensive view of support interactions and their analysis. The dashboard presents data covering a specific time period, as indicated by the date range 503 from Jun. 1, 2022, through Jul. 22, 2022. This temporal context may allow users to focus on relevant data and identify trends or issues within a particular timeframe. The dashboard's organization into three main sections may offer different levels of detail and analysis, potentially enabling users to gain insights at various granularities. In some examples, this multi-layered presentation of data may facilitate both high-level strategic decision-making and detailed operational improvements in support processes. The integration of AI-generated insights with user-friendly visualizations may enhance the ability of support teams to quickly identify and address recurring issues, potentially leading to improved customer satisfaction and more efficient resource allocation.

The top section of the dashboard includes several metadata indicators and drop-down menus that may provide high-level insights and allow for customization of the displayed data. These elements include a start date indicator 504 and end date indicator 506, which may enable users to adjust the time range of the analysis. A hierarchy drop-down menu 508 specifies “date-issue” as the currently selected hierarchy value, suggesting that users may have the option to organize the data based on different hierarchical structures (e.g., date-issue vs. issue-date). Additional indicators provide summary statistics, such as the total number of chats 510, total number of issues 512, and/or total number of generalized issues 514. These metrics may offer a quick overview of the volume and complexity of support interactions within the selected timeframe. In some scenarios, the ability to customize the date range and hierarchy may allow support managers to focus on specific periods of interest, such as during marketing campaigns or system updates, and to analyze the data from different perspectives. The summary statistics may provide a high-level view of support workload and issue complexity, potentially helping in resource planning and identifying trends in customer support needs over time.

The middle section of the dashboard features a series of two-dimensional heat maps, including heat map 518 and heat map 516. Each heat map corresponds to a specific date, such as Jun. 14, 2022, which may represent either a single day or a longer period indexed to that day, such as a week. The heat maps display grids of cells, with the size of each cell potentially varying in proportion to the count of instances for a corresponding issue. The use of color, hatching, and/or other visual indicators, as explained in the heat map legend 503, may provide additional information about the frequency or severity of issues. This visualization technique may allow users to quickly identify patterns, trends, or outliers in the support data. For example, larger or more intensely colored cells may draw attention to particularly prevalent or significant issues, potentially guiding support teams to areas that may benefit from focused attention or resource allocation. In some examples, the heat map visualization may be particularly helpful in identifying seasonal trends, sudden spikes in specific issues, or the impact of system changes on support volume. The ability to visually compare heat maps across different dates may enable support managers to assess the effectiveness of implemented solutions or to anticipate future support needs based on historical patterns.

Below the heat map section, a detailed list of reported issues is presented in a tabular format. Rows 522-538 provide specific information about individual issues, organized into columns for issue date, chats, generalized issue, solution, feedback, and solution acceptance. The issue date column specifies the date of each reported issue, while the chats column includes a user interface element that may allow for expansion or display of the corresponding chat logs. The generalized issue column presents a text string describing the issue after it has been processed and categorized by the AI system. The solution column parallels the chats column, offering a view solution option with an expansion indicator. The feedback column provides a mechanism for rating the solution on a scale of 1-5, potentially allowing for continuous improvement of the support process. The “Accept Solution” column includes a drop-down menu where users may indicate whether they accept the proposed solution. This structured presentation of data may enable support teams to efficiently review and address reported issues, while also collecting valuable feedback on the effectiveness of proposed solutions. In some scenarios, the feedback mechanism may play a role in refining the AI-generated solutions and improving the overall quality of the knowledge base. The ability to view individual chat logs alongside generalized issues and proposed solutions may provide context for support agents, potentially enabling them to understand the nuances of each case and provide more personalized assistance when needed.

In some examples, the recurrence of specific generalized issues across multiple rows, such as “Account Access with Invalid PIN” appearing in rows 522, 524, 530, and 532, may highlight the importance of identifying and addressing recurring problems. This information may be used to prioritize the development of solutions or to update knowledge base articles that address frequently encountered issues. The repetition of generalized issues may also indicate potential systemic problems that may benefit from deeper investigation and/or collaboration with other departments, such as product development or IT infrastructure teams. By identifying these recurring issues, support managers may be able to allocate resources more effectively, potentially reducing the overall volume of support requests and improving customer satisfaction in the long term.

At the bottom of the dashboard, a knowledge base section 544 is presented, featuring three columns: issue date, generalized issue, and solution. This section may serve as a repository of standardized solutions for common issues. Row 540, for instance, addresses “technical issues with system failure” with the solution “a single track ticket needs to be set up to resolve the issue.” Row 542 deals with “plan change functionality issues,” suggesting the solution to “create single track INC for IT intervention to change the plan [and] [e]nsure funds have been applied to the account for the change.” The inclusion of this knowledge base on the dashboard may provide quick access to established solutions, potentially improving the efficiency and consistency of support responses. In some examples, this knowledge base may be dynamically updated based on the effectiveness of solutions as indicated by user feedback, creating a self-improving system that adapts to changing support needs and evolving customer issues. The standardization of solutions through this knowledge base may also contribute to more consistent customer experiences across different support interactions and agents.

A “Download Knowledge Base” button 546 at the bottom of the dashboard may allow users to export the knowledge base for offline use or further analysis. This feature may facilitate knowledge sharing across different support teams or enable integration with other support tools and systems. In some scenarios, the ability to download and distribute the knowledge base may be particularly helpful for training new support agents, conducting offline analysis to identify areas for improvement, and/or creating backup copies of valuable support information. The portability of the knowledge base may also enable its use in situations where real-time access to the dashboard may not be available, potentially ensuring that support agents have access to helpful information even in challenging circumstances.

In some examples, the Chat Analysis Dashboard may incorporate additional key metrics, insights, outputs, and/or input elements beyond those shown in FIG. 5. These supplementary features may enhance the analytical capabilities and/or user experience of the dashboard. For instance, the dashboard may include a sentiment analysis component that evaluates the emotional tone of customer interactions, potentially providing insights into customer satisfaction levels and/or areas of frustration. This sentiment data may be visualized through color-coded heat maps and/or trend lines, allowing support managers to identify patterns in customer emotions over time and/or across different issue types. Additionally, the dashboard may incorporate a response time analysis feature, which may track and/or display average response times for different types of issues, support agents, and/or time periods. This information may be presented as a series of line graphs and/or bar charts, potentially helping managers identify bottlenecks in the support process and/or recognize high-performing team members. The dashboard may also include a predictive analytics component that forecasts future support volume based on historical data and/or external factors such as product releases and/or marketing campaigns. These predictions may be displayed as forecast lines overlaid on historical data charts, potentially aiding in resource planning and/or staffing decisions. Furthermore, the dashboard may feature a customer journey map that visualizes the path customers take through various support channels and/or touchpoints, potentially highlighting common pain points and/or areas for improvement in the overall support experience. The dashboard may also incorporate a word cloud or topic modeling visualization that displays frequently occurring terms and/or themes in customer inquiries, potentially helping identify emerging issues and/or trends. An agent performance scorecard may be included, displaying key performance indicators for individual support agents and/or teams, such as customer satisfaction ratings, issue resolution rates, and/or average handling times. The dashboard may also feature a real-time alert system that notifies managers of sudden spikes in specific issue types and/or unusually long customer wait times, potentially enabling quick responses to developing problems. Additionally, the dashboard may include customizable widgets that allow users to create and/or display personalized metrics and/or visualizations based on their specific needs and/or preferences. A customer feedback analysis section may be incorporated, displaying verbatim comments and/or aggregated ratings from customer surveys, potentially providing direct insights into the voice of the customer. The dashboard may also feature a knowledge base effectiveness metric that tracks how often knowledge base articles are used to resolve issues and/or their impact on resolution times, potentially guiding efforts to improve and/or expand the knowledge base. An AI-powered anomaly detection component may be included, automatically flagging unusual patterns and/or outliers in the support data for further investigation. The dashboard may also incorporate a channel effectiveness comparison, showing how different support channels (e.g., chat, phone, email) perform in terms of resolution times, customer satisfaction, and/or cost-effectiveness. These additional features and/or metrics may be integrated into the existing dashboard layout and/or added as new sections or tabs, potentially providing a more comprehensive and/or customizable view of the support operation's performance.

In some examples, the Chat Analysis Dashboard may incorporate various input methods and/or user interface elements beyond those shown in FIG. 5, potentially enhancing user interaction and/or data manipulation capabilities. Instead of dropdown menus, the system may utilize slider bars for selecting date ranges and/or adjusting threshold values, potentially allowing for more granular control. Multi-select checkboxes may be employed for filtering multiple categories simultaneously, such as issue types and/or agent groups. The dashboard may feature drag-and-drop functionality, enabling users to rearrange dashboard components and/or create custom views. Voice commands may be integrated, allowing hands-free navigation and/or data querying. Gesture-based controls may be implemented for touchscreen devices, facilitating pinch-to-zoom on charts and/or swipe gestures for switching between different dashboard sections. Instead of a fixed 1-5 scale for feedback, the system may offer a continuous slider or a more detailed or higher number scale. The dashboard may include a freeform text input field for natural language queries, potentially leveraging AI to interpret and/or respond to complex analytical questions. Interactive data visualization techniques may be employed, such as clickable elements within charts that reveal additional details and/or drill-down capabilities. The heatmap visualization may be supplemented with or replaced by 3D topographical maps, potentially providing a more immersive view of data trends. Augmented reality features may be incorporated, allowing users to project dashboard elements onto physical spaces and/or interact with data in a 3D environment. The system may offer customizable hotkeys and/or shortcuts for frequent actions, potentially improving efficiency for power users. A color picker tool may be included for personalizing the dashboard's color scheme and/or adjusting data visualization palettes. The dashboard may feature a chatbot interface for guided analytics, potentially assisting users in navigating complex data sets and/or generating insights. Radial menus may be used instead of traditional dropdown lists, potentially offering a more compact and/or visually appealing selection interface. The system may incorporate haptic feedback for mobile devices, providing tactile responses to user interactions with dashboard elements. A pencil tool may be included for freehand annotations on charts and/or graphs, potentially facilitating collaborative analysis and/or note-taking. The dashboard may offer split-screen functionality, allowing users to compare multiple data views side-by-side. Zoomable treemaps may be used to represent hierarchical data structures, potentially offering an alternative to traditional organizational charts and/or issue categorizations. The system may include a visual query builder, enabling users to construct complex data filters and/or analyses through a drag-and-drop interface. These varied input methods and/or user interface elements may be mixed and/or matched in different combinations, potentially creating a highly customizable and/or intuitive user experience tailored to diverse user preferences and/or analytical needs.

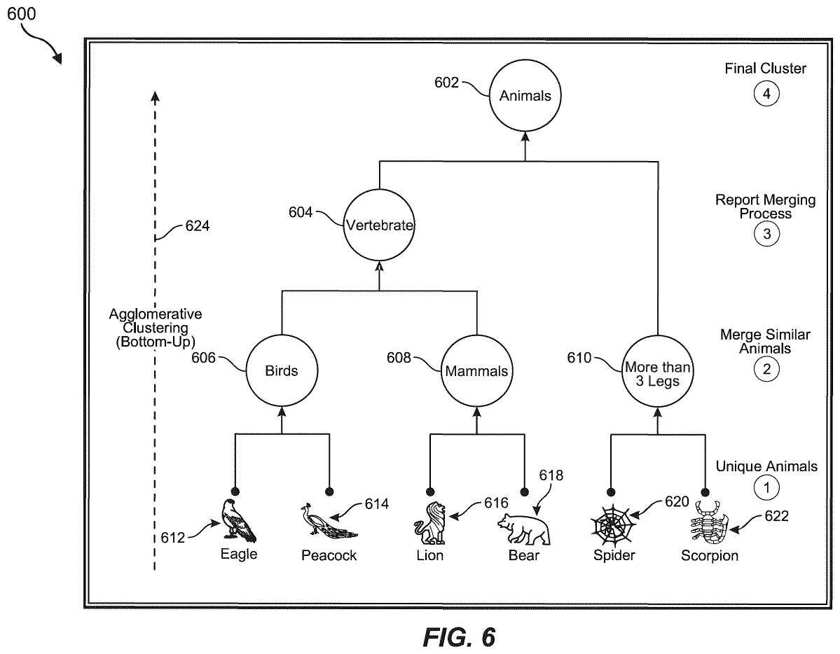

FIG. 6 shows an example illustration of the concept of agglomerative clustering, labeled as 600. This figure may provide a visual representation of how hierarchical clustering techniques may be applied to categorize and organize data, potentially offering insights into how support issues may be grouped and analyzed in the context of AI-powered customer support systems. The overall structure of the figure is organized into a hierarchy with four main levels, each representing a different stage in the clustering process. These levels may correspond to increasingly generalized categories, demonstrating how specific instances may be grouped into broader classifications. In some examples, this visualization technique may be helpful in understanding the progression from individual data points to comprehensive categories, which may be analogous to the process of categorizing and generalizing customer support issues in an AI-driven system. The hierarchical nature of the clustering process may allow for flexibility in determining the appropriate level of generalization for different analytical purposes, potentially enabling support teams to view issues at varying levels of granularity depending on their specific needs and/or objectives.

A dashed arrow 624 points vertically upward on the left side of the figure, potentially indicating the direction of the clustering process from specific to general. This arrow may symbolize the aggregation of data points into increasingly broader categories as the clustering algorithm progresses. This concept may be relevant in the context of customer support, where new types of issues may emerge over time, and the categorization system may desire to adapt and evolve to accommodate these changes.

The central part of the figure displays a hierarchical structure with four main rows, each representing a different level of categorization. At the top level, labeled as “animals” 602, we see the most general category. This may represent the final result of the clustering process, where all subcategories have been merged into a single, all-encompassing group. Below this, the second level shows “vertebrae” 604, which may represent a more specific subcategory of animals. The third level further divides the categories into “birds” 606, “mammal” 608, and “more than 3 legs” 610. These categories may demonstrate how the clustering algorithm identifies and groups similar characteristics across different data points. The bottom level, which represents the most specific categories, includes “Eagle” 612, “Peacock” 614, “Lion” 616, “Bear” 618, “Spider” 620, and “Scorpion” 622. These specific examples may correspond to individual data points or the most granular level of classification in the dataset. In the context of customer support, this hierarchical structure may be analogous to the categorization of support tickets, where individual customer issues (represented by specific animals) may be grouped into broader categories (such as types of problems or affected systems) and ultimately into high-level categories that may inform strategic decision-making. The inclusion of diverse examples at the bottom level (e.g., birds, mammals, and arthropods) may illustrate how agglomerative clustering may handle a wide range of distinct issues, potentially making it suitable for complex support environments with diverse customer concerns.

The relationships between these categories are illustrated by arrows showing the specific and precise connections within the hierarchy. Eagles 612 and Peacocks 614 are shown pointing into the Birds category 606, while Lions 616 and Bears 618 point into the Mammals category 608. Spiders 620 and Scorpions 622 are grouped under the “More than 3 legs” category 610. This visual representation may help users understand how the clustering algorithm identifies similarities and groups data points based on shared characteristics. The arrows pointing from Birds 606 and Mammals 608 into Vertebrae 604, but not from “More than 3 legs” 610, may illustrate how the algorithm distinguishes between vertebrates and invertebrates at this level of classification. Finally, both Vertebrae 604 and “More than 3 legs” 610 point to the top-level Animals category 602, showing the final merging of all subcategories into a single, comprehensive group. In the context of customer support, these relationships may represent how specific customer issues may be grouped based on common underlying factors, such as the affected product features, the nature of the problem (e.g., technical vs. billing), and/or the required resolution steps. The visual representation of these relationships may help support teams understand the connections between different types of issues, potentially leading to more efficient problem-solving and knowledge sharing across different support areas.

The rightmost side of the figure labels each level of the hierarchy, providing context for the stages of the clustering process. The bottom level, corresponding to Eagles 612, Peacocks 614, Lions 616, Bears 618, Spiders 620, and Scorpions 622, is labeled as “Unique Animals 1”. This may represent the starting point of the clustering process, where each data point is considered a unique entity. The third level, which includes Birds 606, Mammals 608, and “More than 3 legs” 610, is labeled as “Merge Similar Animals 2”. This label may indicate the first stage of clustering, where the algorithm begins to group similar entities based on shared characteristics. The second level, corresponding to Vertebrae 604, is labeled as “Report Merging Process 3”. This may represent a further stage of aggregation, where broader categories are formed from the previously merged groups. Finally, the top level, corresponding to Animals 602, is labeled as “Final Cluster 4”, indicating the end result of the clustering process where all subcategories have been merged into a single, comprehensive group. In the context of AI-powered customer support, these stages may be analogous to the process of analyzing and categorizing support tickets. The “Unique animals” stage may correspond to individual customer issues, the “Merge similar animals” stage may represent the grouping of related problems, the “Report merging process” may involve creating broader categories of issues, and the “Final cluster” may represent high-level insights about overall support trends and/or challenges. This staged approach to clustering may allow support teams to analyze data at different levels of granularity, potentially enabling both detailed problem-solving and high-level strategic planning based on the same underlying data.

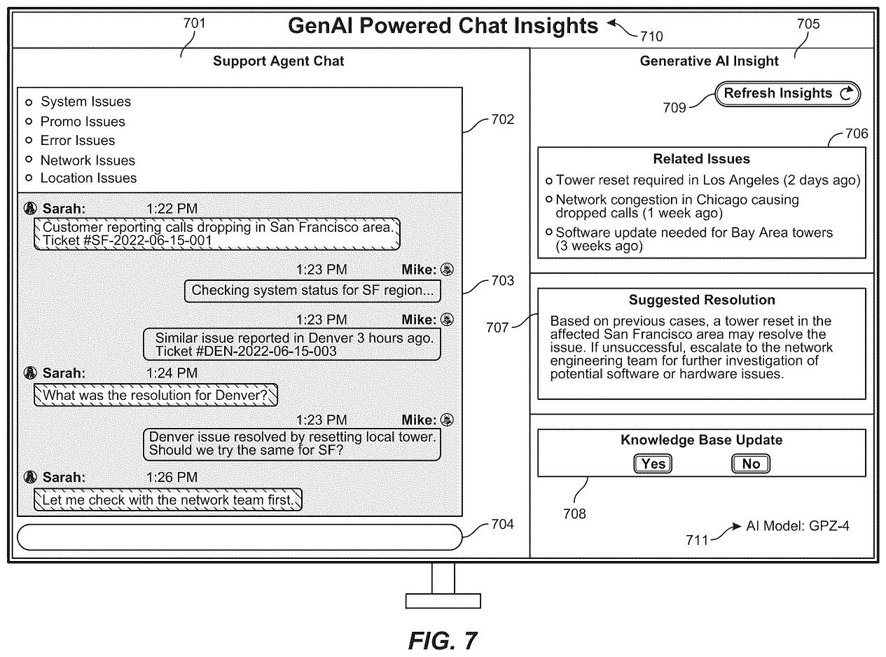

FIG. 7 shows an example of an agent-agent chat interface with generative AI insights. The figure presents a split-screen interface that may be helpful in scenarios where support agents desire to quickly access relevant information and suggestions while engaging in real-time conversations with colleagues. In some examples, this integrated approach may lead to faster problem resolution and/or improved knowledge sharing among support team members. The split-screen design may also allow for simultaneous viewing of ongoing conversations and AI-generated insights, potentially reducing the cognitive load on agents and enabling them to focus more effectively on addressing customer issues.

On the left side of the split-screen, a chat interface labeled “Support Agent Chat” 701 is displayed. This interface may resemble a modern messaging application with a clean, professional design, potentially facilitating ease of use and clarity in communication between support agents. The leftmost portion of this chat interface shows a list of chat threads 702. This list may include at least five thread previews, each featuring a small circular avatar and/or a name (such as “System Issues” or “Promo Issues”). This organization may allow agents to quickly navigate between different ongoing conversations and prioritize their responses based on the nature and urgency of the issues being discussed. The thread list 702 may also serve as a visual indicator of the overall volume and diversity of support issues being handled by the team at any given time. In some scenarios, this overview may help managers identify areas where additional resources or training may be beneficial, potentially leading to improved overall support efficiency and/or quality.

A main chat window 703 and a text input box 704 are shown, which may provide a clear and intuitive area for agents to compose and send their messages. Within the main chat window 703, a conversation between two support agents discussing a customer issue is displayed. The conversation includes six message bubbles with text, alternating between Agent 1 (Sarah) and Agent 2 (Mike). The messages discuss a customer report of calls dropping in the San Francisco area, with references to similar issues in Denver and potential resolutions. Timestamps next to each message may provide context for the timing and flow of the conversation. This detailed view of the agent-to-agent interaction may offer insights into how support teams collaborate and share information in real-time.

On the right side of the split-screen, a “Generative AI Insights” panel 705 is shown with a light blue background, visually differentiating it from the chat interface. This panel may be divided into several sections. The “Related Issues” section 706 lists three bullet points of similar issues, such as “Tower reset required in Los Angeles (2 days ago)” and “Network congestion in Chicago causing dropped calls (1 week ago)”. This information may help agents quickly identify patterns or recurring problems across different geographic locations and/or time periods. The “Suggested Resolution” section 707 provides a brief paragraph outlining a potential solution based on previous cases. This feature may assist agents in quickly formulating response strategies and may reduce the time needed to resolve customer issues. The “Knowledge Base Update” section 708 includes a prompt asking if the current issue should be added to the knowledge base, with “Yes” and “No” buttons below it. This feature may facilitate the continuous improvement of the support system's knowledge base, potentially leading to more efficient issue resolution in the future. The AI insights panel 705 may play a role in augmenting human decision-making by providing relevant contextual information and/or suggestions. In some examples, this AI-assisted technique may lead to more consistent and effective support responses across different agents and scenarios.

At the top of the right panel, a “Refresh Insights” button 709 with a circular arrow icon is included. This button may allow agents to manually update the AI-generated insights if desired, helping them to have access to the most current and relevant information. The entire interface is topped with a header displaying the text “GenAI Powered Chat Insights” 710 in a large, bold font, potentially emphasizing the integration of AI technology in the support process. In the bottom right corner of the Generative AI Insights panel, a small label reading “AI Model: GPZ-4” 711 indicates the specific AI model being used, which may be helpful for agents in understanding the capabilities and/or potential limitations of the AI-generated insights. These interface elements may contribute to a more transparent and user-friendly AI-assisted support environment. The ability to refresh insights manually may be particularly valuable in rapidly evolving situations, where new information may become available quickly. The labeling of the AI model in use may help set appropriate expectations for the insights provided and/or may assist in troubleshooting or improving the system over time.

In some examples, this interface may significantly enhance the efficiency and effectiveness of support agent interactions. The real-time analysis of ongoing conversations by the generative AI model may provide relevant insights and/or suggestions, potentially facilitating quicker problem-solving and knowledge sharing among support agents. The AI model's ability to identify patterns across different geographic locations and/or time periods may enable agents to leverage solutions from similar past cases, potentially reducing resolution times and/or improving consistency in customer support. The knowledge base update feature may play a helpful role in continuously improving the system's effectiveness by capturing new insights and/or solutions as they are discovered. This ongoing refinement of the knowledge base may lead to a more comprehensive and/or up-to-date resource for agents to draw upon in future interactions. The integration of human expertise with AI-generated insights may create a synergistic effect, potentially leading to more informed decision-making and improved overall support quality.

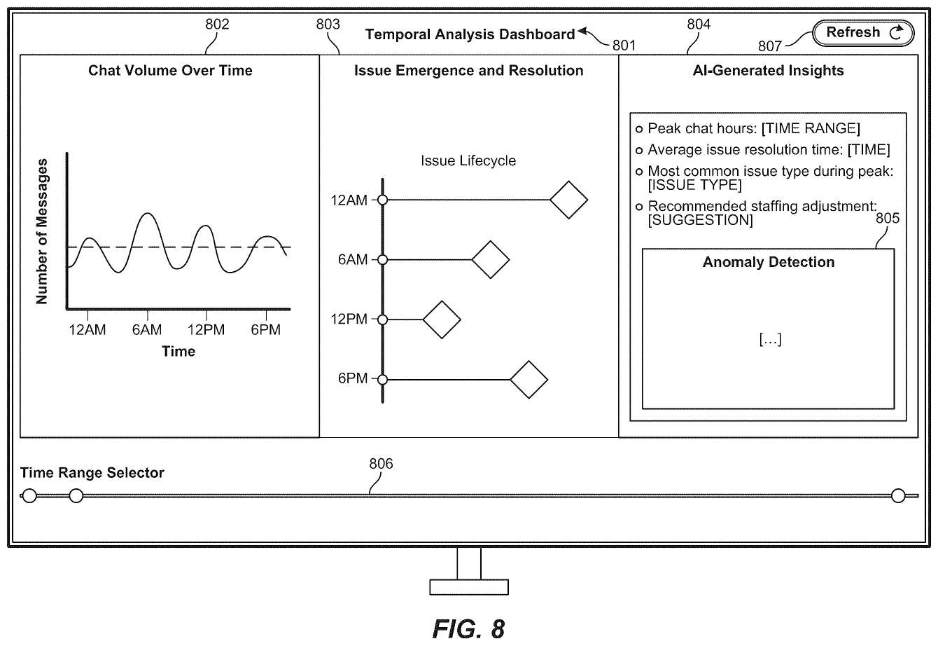

FIG. 8 shows an example of a Temporal Analysis Dashboard 801 that may provide insights into the temporal patterns of support agent chat data. This dashboard may offer a view of chat volume, issue lifecycle, and/or AI-generated insights, potentially enabling support managers to make data-driven decisions about resource allocation and process improvements. The dashboard may be particularly helpful in scenarios where support teams desire to understand and respond to fluctuating workloads, identify recurring patterns in customer issues, and/or proactively address potential problems before they escalate. In some examples, the temporal analysis provided by this dashboard may lead to more efficient staffing decisions, improved response times, and/or enhanced overall customer satisfaction. The integration of AI-generated insights with visual representations of chat data may create a powerful tool for support managers to gain a deeper understanding of their team's performance and the challenges they face over time.

The left section 802 of the dashboard presents a “Chat Volume Over Time” graph. This graph may display the number of messages against time, with the latter divided into hours. A wavy line plotted on this graph may represent the fluctuations in chat volume throughout the day, with peaks and troughs potentially indicating busy and quiet periods. A dotted horizontal line across the graph may represent the average chat volume, providing a reference point for comparing volume at different times. This visualization may allow support managers to identify patterns in chat activity, such as recurring busy periods or unexpected spikes in volume. In some examples, this information may be used to adjust staffing levels, plan training sessions during quieter periods, and/or prepare for anticipated increases in support demand. The ability to visualize chat volume trends over time may also help in identifying seasonal patterns or the impact of specific events (such as product launches or marketing campaigns) on support workload. Support managers may use these insights to develop more accurate forecasting models for resource allocation and to create contingency plans for handling periods of high demand. Additionally, the comparison between actual chat volume and the average line may help in setting realistic performance targets and/or identifying opportunities for improving efficiency during both peak and off-peak hours.

The middle section 803 focuses on “Issue Emergence and Resolution,” providing a visual representation of the issue lifecycle. This section may feature a vertical timeline corresponding to the hours marked on the left section's x-axis. Along this timeline, small circles may represent newly emerging issues, with horizontal lines extending from these circles to diamond shapes representing issue resolution. The varying lengths of these lines may indicate different resolution times for different issues. This “Issue Lifecycle” visualization may offer insights into how quickly different types of issues are being resolved and whether there are patterns in when certain types of issues tend to emerge. Support managers may use this information to identify bottlenecks in the resolution process, allocate resources more effectively, and/or develop strategies for addressing common issues more efficiently. The visual representation of issue lifecycles may also help in identifying correlations between issue types and resolution times, potentially leading to more targeted training programs or the development of specialized teams for handling specific categories of issues. In some scenarios, this visualization may reveal opportunities for implementing automated solutions or self-service options for frequently occurring issues with short resolution times, potentially freeing up human agents to focus on more complex problems.

The right section 804 of the dashboard presents “AI-Generated Insights,” which may provide a summary of key metrics and/or recommendations based on the analyzed data. This section may include information such as peak chat hours, average issue resolution time, the most common issue type during peak hours, and/or recommended staffing adjustments. These insights may help support managers make informed decisions about resource allocation, training priorities, and/or process improvements. Below this, an “Anomaly Detection” subsection 805 may provide brief descriptions of any unusual patterns detected by the AI. This feature may alert managers to potential problems or unexpected trends that may indicate further investigation or immediate action. The AI-generated insights may play a helpful role in augmenting human decision-making by providing data-driven recommendations and highlighting patterns that might not be immediately apparent through manual analysis. In some examples, these insights may be used to develop predictive models for anticipating support needs, allowing organizations to take a more proactive approach to customer service. The anomaly detection feature may be particularly valuable in identifying emerging issues or unexpected changes in customer behavior, potentially enabling support teams to respond quickly to new challenges or opportunities.

At the bottom of the dashboard, a time range selector 806 may allow users to adjust the time period for which data is displayed. This feature may enable support managers to focus on specific time frames of interest, such as comparing different days of the week or examining trends over longer periods. The flexibility provided by this time range selector may be particularly helpful in conducting root cause analyses for specific issues or in assessing the impact of implemented changes over time. In the top right corner, a “Refresh” button 807 with a circular arrow icon may allow users to update the displayed data. The ability to refresh data on demand may be helpful in scenarios where real-time decision-making is important, such as during major product releases or when responding to unexpected spikes in support volume.

In some examples, this temporal analysis dashboard may significantly enhance the ability of support managers to understand and respond to patterns in support agent interactions. The visualization of chat volume over time may provide insights into the ebb and flow of support issues, potentially allowing for more efficient staffing decisions and/or improved customer response times. The issue lifecycle visualization may help identify trends in issue emergence and/or resolution, which may inform process improvements and/or resource allocation strategies. The AI-generated insights may offer actionable recommendations based on the analyzed data, potentially leading to more informed decision-making and/or improved overall support quality. By combining these various elements into a single, integrated dashboard, support managers may gain a more comprehensive understanding of their team's performance and/or the factors influencing customer support needs over time. This holistic view may enable more strategic planning and/or decision-making, potentially leading to improvements in customer satisfaction, agent productivity, and/or overall operational efficiency.

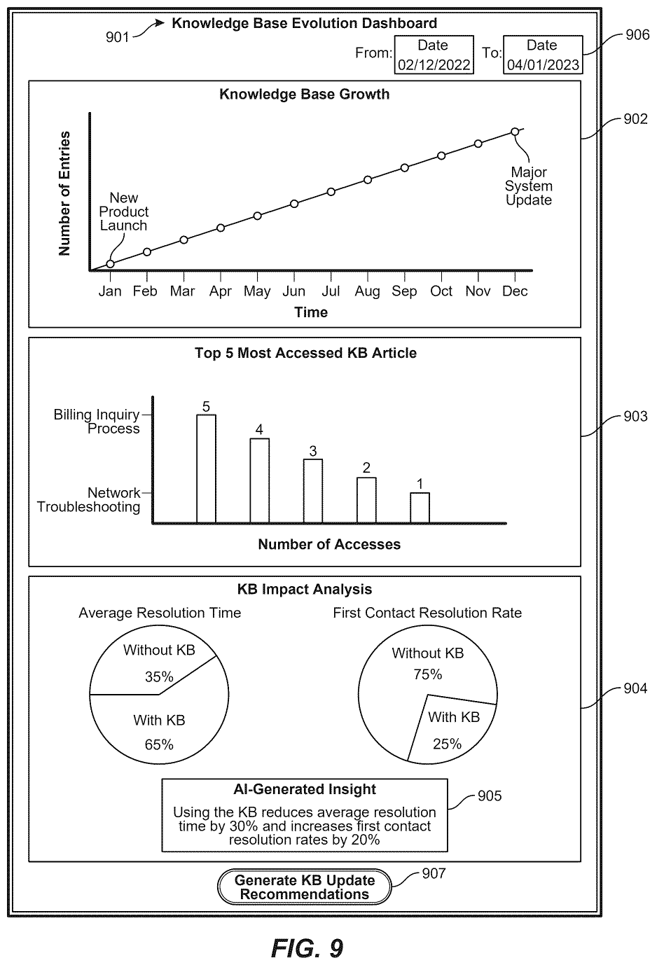

FIG. 9 shows an example of a Knowledge Base Evolution Dashboard 901 that may provide a view of the knowledge base's growth and/or impact over time. This dashboard may offer valuable insights into the effectiveness and/or utilization of the knowledge base, potentially enabling support managers to make data-driven decisions about content creation, maintenance, and/or improvement strategies. The dashboard may be helpful in scenarios where support teams desire to understand the relationship between knowledge base development and support efficiency, identify high-impact content, and/or prioritize areas for further documentation. In some examples, the analysis provided by this dashboard may lead to more efficient resource allocation for content creation, improved support agent productivity, and/or enhanced overall customer satisfaction. The integration of AI-generated insights with visual representations of knowledge base data may create a powerful tool for support managers to gain a deeper understanding of their knowledge management strategies and/or the impact on support operations over time.

The top section 902 of the dashboard presents a “Knowledge Base Growth” graph. This graph may display the number of knowledge base entries against time, with the latter divided into months. A steadily increasing line plotted on this graph may represent the growth of knowledge base entries over time, with data points marked by small circles. Key points along the line may be annotated with brief descriptions of significant events, such as new product launches and/or major system updates. This visualization may allow support managers to track the expansion of the knowledge base and/or correlate its growth with specific events and/or initiatives. In some examples, this information may be used to assess the impact of product changes on support documentation needs, identify periods of rapid knowledge base expansion, and/or evaluate the effectiveness of content creation efforts. The ability to visualize knowledge base growth trends over time may also help in identifying potential gaps in documentation and/or areas where content may benefit from updating. Support managers may use these insights to allocate resources for content creation and/or maintenance more effectively, potentially leading to a more comprehensive and/or up-to-date knowledge base. Additionally, the annotations of events may help in understanding the relationship between organizational changes and/or product updates and the corresponding impact on support documentation needs or preferences, potentially enabling more proactive planning for future initiatives.

The middle section 903 of the dashboard features a “Top 5 Most Accessed KB Articles” chart. This horizontal bar chart may display the most frequently accessed knowledge base articles, with the y-axis showing generic article titles (such as “Network troubleshooting” and/or “Billing inquiry process”) and the x-axis representing the number of accesses. The varying lengths of the bars may visually represent the relative popularity of different articles, with the actual number of accesses noted at the end of each bar. This visualization may provide valuable insights into which types of content are most frequently utilized by support agents and/or customers. Support managers may use this information to identify high-impact articles that may benefit from regular updates and/or expansion, as well as potential areas where additional content may be needed to address frequently occurring issues. The analysis of most accessed articles may also inform training programs for support agents, highlighting areas where deeper knowledge may be valuable. In some scenarios, this data may be used to improve the organization and/or accessibility of the knowledge base, ensuring that the most valuable content is easily discoverable. Furthermore, tracking changes in the most accessed articles over time may provide insights into evolving customer needs and/or emerging support trends, potentially enabling more proactive content development strategies.

The bottom section 904 of the dashboard presents a “KB Impact Analysis” through two side-by-side pie charts. The left pie chart, labeled “Average Resolution Time,” may be divided into two slices representing resolution times with and without knowledge base usage. Similarly, the right pie chart, labeled “First Contact Resolution Rate,” may show the rates of issues resolved on first contact with and without knowledge base assistance. These visualizations may provide a clear comparison of support efficiency metrics with and without knowledge base utilization. Below the pie charts, an “AI-Generated Insight” 905 text box may offer a brief statement about the impact of the knowledge base on support efficiency. This analysis may help support managers quantify the value of the knowledge base in terms of tangible metrics such as reduced resolution times and/or improved first contact resolution rates. In some examples, these insights may be used to justify investments in knowledge base development and/or maintenance, demonstrate the return on investment of knowledge management initiatives, and/or identify areas where the knowledge base may be particularly effective in improving support outcomes. The AI-generated insights may also highlight potential areas for improvement, such as content categories that may benefit from expansion and/or refinement to further enhance support efficiency.

In the top right corner of the dashboard, a date range selector 906 may allow users to adjust the time period for which data is displayed. This feature may enable support managers to focus on specific time frames of interest, such as comparing different quarters and/or examining trends over longer periods. The flexibility provided by this time range selector may be particularly helpful in conducting analyses of the knowledge base's impact over time, assessing the effectiveness of specific content development initiatives, and/or identifying seasonal trends in knowledge base usage and/or effectiveness. At the bottom of the screen, a “Generate KB Update Recommendations” button 907 may allow users to request AI-generated suggestions for knowledge base improvements based on the analyzed data. This feature may facilitate continuous improvement of the knowledge base by identifying areas that may benefit from updates, expansion, and/or reorganization. In some scenarios, these recommendations may help prioritize content development efforts, ensure that the knowledge base remains aligned with current support needs, and/or proactively address emerging issues before they impact support efficiency.

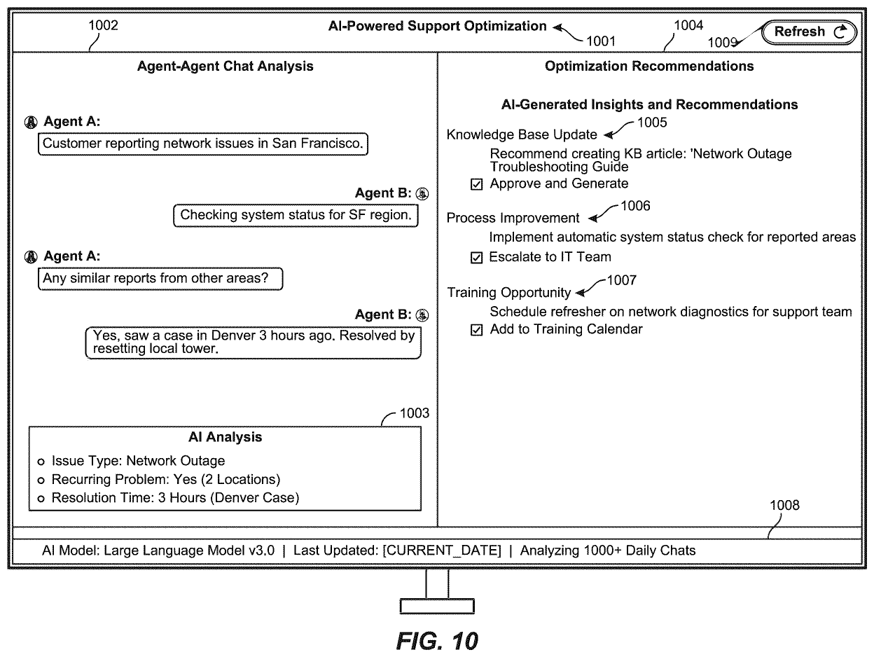

FIG. 10 shows an example of an AI-Powered Support Optimization interface 1001. This interface may provide a comprehensive view of agent-agent chat analysis and/or AI-generated optimization recommendations. The split-screen layout may enable simultaneous viewing of ongoing conversations and/or AI-derived insights, potentially facilitating real-time decision-making and/or support process improvements. In some examples, this interface may be particularly helpful for support managers and/or team leads who desire to monitor and/or improve the efficiency of their support operations in real-time. The integration of chat analysis with AI-generated recommendations may create a dynamic feedback loop, potentially enabling continuous refinement of support processes, knowledge base content, and/or training programs. This holistic technique to support optimization may lead to improved response times, increased first-contact resolution rates, and/or enhanced overall customer satisfaction.

The left section 1002 of the interface, labeled “Agent-Agent Chat Analysis,” displays a simplified chat interface with message bubbles representing a conversation between two agents. This conversation may cover a specific customer issue, such as network problems in San Francisco. The inclusion of actual chat content may provide context for the AI analysis and/or recommendations shown elsewhere in the interface. Below the chat display, an “AI Analysis” text box 1003 presents key insights derived from the conversation. These insights may include the issue type, whether it's a recurring problem, and/or the resolution time based on similar past cases. This real-time analysis may help support agents quickly identify patterns and/or leverage previous solutions, potentially reducing resolution times and/or improving consistency in problem-solving techniques. The AI analysis may also serve as a form of automated quality assurance, potentially flagging conversations that may require additional attention or follow-up. In some scenarios, this real-time analysis may be used to provide immediate feedback to agents, potentially helping them improve their performance on-the-fly and/or adhere to best practices in customer communication.

In some examples, the AI analysis may go beyond simple categorization and/or may identify subtle connections between seemingly unrelated issues. For instance, the system may recognize that network outages in different locations may share common root causes, even if they manifest differently. This deeper level of analysis may enable support teams to address underlying issues more effectively, potentially preventing future occurrences across multiple regions. Additionally, the real-time nature of this analysis may allow for dynamic prioritization of issues, ensuring that the most pressing and/or widespread problems receive immediate attention. The system may also be capable of identifying emerging trends or patterns in customer issues, potentially enabling support teams to proactively address problems before they become widespread. This predictive capability may be helpful in reducing overall support volume and/or improving customer satisfaction by addressing issues before they impact a larger user base.

The right section 1004 of the interface, titled “Optimization Recommendations,” presents AI-generated insights and/or recommendations based on the analyzed chat data. This section may be divided into three subsections, each addressing a different aspect of support optimization. The “Knowledge Base Update” subsection 1005 may suggest creating new knowledge base articles based on recurring issues identified in the chats. For example, it may recommend creating a “Network Outage Troubleshooting Guide” to address the issue discussed in the sample conversation. The inclusion of an “Approve and Generate” checkbox may allow for quick action on these recommendations, potentially streamlining the process of keeping the knowledge base up-to-date and/or relevant. This automated suggestion system may help ensure that the knowledge base remains a living document, continuously evolving to meet the changing needs of both customers and/or support agents. In some scenarios, the AI may also suggest updates or revisions to existing knowledge base articles, potentially helping to maintain the accuracy and/or effectiveness of the support documentation over time.

The “Process Improvement” subsection 1006 may offer suggestions for enhancing support workflows and/or procedures. In the given example, it recommends implementing an automatic system status check for reported areas. This type of recommendation may help identify opportunities for automation and/or proactive problem detection, potentially reducing the workload on support agents and/or improving response times. The “Escalate to IT Team” checkbox may facilitate quick handoffs to relevant departments for implementation of these improvements. By identifying potential process improvements, the AI system may help support organizations continuously refine their operations, potentially leading to increased efficiency and/or reduced operational costs. These recommendations may also help in standardizing support processes across different teams or locations, ensuring consistency in customer service delivery. In some examples, the system may prioritize process improvement suggestions based on their potential impact, helping support managers focus on changes that may yield the greatest benefits.

In some examples, fine tuning the LLM based on feedback from a support agent account may involve various techniques to improve the model's performance and relevance in the context of customer support. The fine-tuning process may utilize a range of feedback types, such as explicit ratings provided by support agents on the accuracy and helpfulness of LLM-generated responses, implicit feedback derived from the agents' interactions with the system, and/or corrections or modifications made to LLM outputs. The system may employ a continuous learning technique, where feedback is incorporated in real-time to make incremental improvements to the model. Alternatively, a batch update technique may be used, accumulating feedback over a specified period before applying updates. The fine-tuning process may focus on domain-specific vocabulary and context, potentially improving the LLM's understanding of industry-specific terminology and support scenarios. In some implementations, the system may use a federated learning technique, allowing multiple support centers or teams to contribute to the model's improvement while maintaining data privacy. The fine-tuning may also involve adjusting the model's temperature or other hyperparameters based on agent feedback to strike a balance between creativity and accuracy in generated responses. Additionally, the system may incorporate a feedback prioritization mechanism, giving more weight to feedback from experienced agents and/or feedback related to high-impact or frequently occurring issues. The fine-tuning process may also include techniques for detecting and mitigating biases that may emerge from agent feedback, ensuring the model maintains fairness and objectivity in its responses.

In some examples, generating a confidence score for each respective generalized issue that indicates a level of certainty in accuracy of the respective generalized issue may involve various techniques and/or considerations. The system may employ probabilistic models, such as Bayesian inference, to calculate the confidence score based on the frequency and consistency of similar issues appearing in the analyzed chat transcripts. Alternatively, the confidence score may be derived from the clustering process, where tighter and more distinct clusters may result in higher confidence scores for their associated generalized issues. The system may also incorporate semantic similarity measures between the generalized issue and the original chat transcripts, potentially using techniques like cosine similarity or Jaccard index to quantify the alignment between the generalized description and the source data. In some implementations, the confidence score may be influenced by the performance of the LLM in generating consistent outputs for similar inputs, potentially tracked over time to account for model stability. The system may also consider the diversity of support agents and/or customers associated with the underlying issues, where a generalized issue derived from a wider range of sources may receive a higher confidence score. Additionally, the confidence score generation process may take into account external factors, such as the recency of the underlying data and/or the relevance of the issue to current product or service offerings. The system may employ ensemble methods, combining multiple scoring techniques to produce a more robust confidence metric. In some scenarios, the confidence score may be dynamically updated as new data becomes available, potentially using techniques like exponential moving averages to balance historical confidence with recent trends. The confidence score may also be calibrated using human expert evaluations, where a subset of generalized issues is manually reviewed and scored, providing a basis for adjusting the automated scoring mechanism.

In some examples, the technological service provided by the communications service provider may encompass a wide range of advanced telecommunications and/or media distribution technologies. While fifth generation or later cellular network services and satellite television services are prominent examples, the scope of applicable technologies may extend far beyond these specific implementations. For instance, the service may include next-generation wireless broadband networks, such as millimeter-wave based systems or future iterations of cellular technology that may surpass current 5G capabilities. The provider may also offer advanced fiber-optic based services, combining ultra-high-speed internet with interactive television and smart home integration. In some scenarios, the service may incorporate emerging technologies like low-earth orbit satellite internet constellations, providing global coverage with low latency. The provider may extend its offerings to include augmented and virtual reality content delivery networks, catering to immersive entertainment and remote collaboration needs. Additionally, the service may encompass Internet of Things (IoT) platforms, managing vast networks of connected devices and sensors for smart cities, industrial applications, and consumer electronics. The provider may also offer edge computing services, bringing processing power closer to end-users to support real-time applications and reduce network congestion. In some implementations, the service may include quantum communication networks, leveraging quantum entanglement for ultra-secure data transmission. The technology may also extend to advanced broadcasting services, such as 8K or higher resolution content delivery, holographic television, or personalized content streams powered by artificial intelligence. Furthermore, the provider may offer integrated communication platforms that blend various technologies, creating a unified service ecosystem that adapts to users' changing needs and contexts across different devices and environments.

In some examples, the AI-powered subscriber support system may be applicable to a wide range of businesses and industries beyond telecommunications and technology services. This support technique may be implemented in various sectors where customer or client interactions generate large volumes of text-based data that could benefit from automated analysis and knowledge extraction. For instance, financial institutions such as banks, insurance companies, and investment firms may employ this system to improve their customer support operations, analyzing client inquiries about account issues, policy claims, or investment strategies. Retail and e-commerce businesses may utilize the system to process customer feedback, product inquiries, and order-related issues, potentially leading to improved product recommendations and streamlined shopping experiences. In the healthcare sector, the system may be adapted to analyze patient inquiries, appointment scheduling requests, and medical information queries, while maintaining strict privacy and confidentiality standards. Educational institutions may implement this support system to handle student inquiries about coursework, administrative procedures, and campus services. Travel and hospitality industries may benefit from the system by processing tourist inquiries, booking-related issues, and travel recommendations. Government agencies may employ the system to improve citizen services, analyzing public inquiries about regulations, permit applications, or social services. In the automotive industry, the system may be used to process customer inquiries about vehicle features, maintenance schedules, and dealer services. Legal firms may adapt the system to analyze client inquiries, categorize legal issues, and provide preliminary guidance. Non-profit organizations may utilize the system to process donor inquiries, volunteer applications, and program-related questions. The system may also be applicable in the entertainment industry, analyzing fan feedback, ticket inquiries, and content-related questions for media companies, sports teams, or event organizers.

In some examples, the system may automatically generate an alert when a frequency of a particular respective generalized issue exceeds a predetermined threshold and send the alert to a corresponding support team. This alert generation process may involve various techniques and considerations to ensure timely and relevant notifications. The system may employ dynamic thresholding algorithms that adjust the predetermined threshold based on historical data patterns, potentially accounting for seasonal variations or known cyclical trends in support issues. The frequency calculation may be performed using different time windows, such as hourly, daily, or weekly intervals, to capture both sudden spikes and gradual increases in issue occurrence. In some implementations, the system may use weighted frequency calculations, giving more importance to recent occurrences or issues reported by high-priority customers. The alert generation may also consider the severity or impact of the issues, potentially lowering the threshold for critical problems that may significantly affect user experience or business operations. The system may incorporate machine learning models to predict issue frequencies and generate proactive alerts before the threshold is reached. In terms of alert distribution, the system may use a multi-tiered technique, sending different levels of alerts to various support team members based on their roles and responsibilities. The alerts may be delivered through multiple channels, such as email, SMS, push notifications, or integration with existing ticketing systems. Additionally, the system may include context-rich information in the alerts, such as relevant knowledge base articles, similar past incidents, and suggested action items. The alert mechanism may also feature an acknowledgment system, ensuring that the notifications are received and acted upon by the appropriate team members.

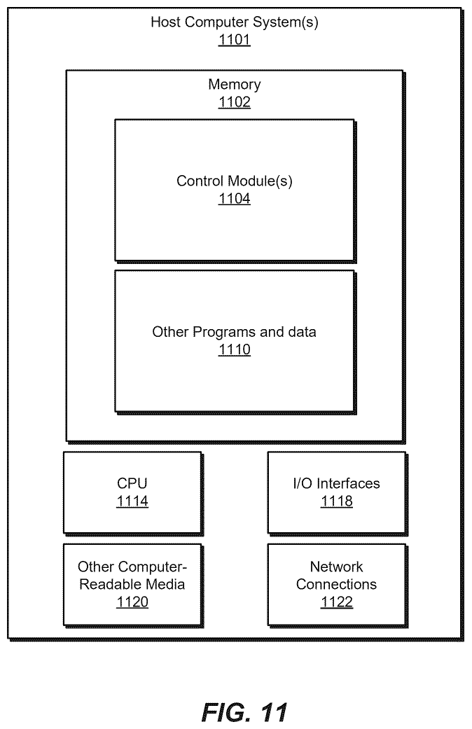

FIG. 11 shows a system diagram that describes an example implementation of a computing system(s) for implementing embodiments described herein. The functionality described herein may be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, enabling higher deployment agility and flexibility. However, FIG. 11 illustrates an example of underlying hardware on which such software and functionality may be hosted and/or implemented.

In particular, shown is example host computer system(s) 1101. For example, such computer system(s) 1101 may execute a scripting application, or other software application, as further discussed above, and/or to perform one or more of the other methods described herein. In some embodiments, one or more special-purpose computing systems may be used to implement the functionality described herein. Accordingly, various embodiments described herein may be implemented in software, hardware, firmware, or in some combination thereof. Host computer system(s) 1101 may include memory 1102, one or more central processing units (CPUs) 1114, I/O interfaces 1118, other computer-readable media 1120, and network connections 1122.

Memory 1102 may include one or more various types of non-volatile and/or volatile storage technologies. Examples of memory 1102 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 1102 may be utilized to store information, including computer-readable instructions that are utilized by CPU 1114 to perform actions, including those of embodiments described herein.

Memory 1102 may have stored thereon control module(s) 1104. The control module(s) 1104 may be configured to implement and/or perform some or all of the functions of the systems or components described herein. Memory 1102 may also store other programs and data 1110, which may include rules, databases, application programming interfaces (APIs), software containers, nodes, pods, clusters, node groups, control planes, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other NFs, etc.

Network connections 1122 are configured to communicate with other computing devices to facilitate the functionality described herein. In various embodiments, the network connections 1122 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 1118 may include a video interface, other data input or output interfaces, or the like. Other computer-readable media 1120 may include other types of stationary or removable computer-readable media, such as removable flash drives, external hard drives, or the like.

The various embodiments described above may be combined to provide further embodiments. These and other changes may be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
receiving chat transcripts from multiple chat groups for a communications service provider where the chat transcripts include distinct support agent accounts of the communications service provider exchanging information about support tickets issued by subscribers who subscribe to a technological service provided by the communications service provider;
prompting a large language model (LLM) such that initial issues are generated based on the chat transcripts;
vectorizing the initial issues through semantic vector embedding;
clustering the vectorized initial issues such that issue clusters are formed;
applying a same or different LLM to each respective issue cluster of the issue clusters such that a respective generalized issue from the respective issue cluster is extracted and populated into a standardized knowledge database; and
resolving, by a support agent account, a support ticket at least in part by referencing a dashboard that provides an interface to the standardized knowledge database.

2. The method of claim 1, further comprising storing a standardized answer associated with the respective generalized issue in the standardized knowledge database.

3. The method of claim 1, further comprising:
identifying a repeating generalized issue occurring across multiple time periods in the chat transcripts; and
automatically generating, in response to identifying the repeating generalized issue, a draft knowledge base article that includes a standardized service procedure that addresses the repeating generalized issue.

4. The method of claim 1, further comprising:
refining or engineering a prompt for prompting the LLM based on feedback from the support agent accounts.

5. The method of claim 1, further comprising converting the chat transcripts into a sequential format by performing at least one of:
extracting multiple distinct threads from a single chat transcript of the chat transcripts such that the multiple distinct threads are separated from an interwoven state in the single chat transcript;
extracting a single chat thread from across multiple chat transcripts of the chat transcripts such that the single chat thread is assembled from portions dispersed across the multiple chat transcripts;
grouping messages across multiple chat transcripts based on semantic similarity to a respective generalized issue;
standardizing a format of the chat transcripts from various sources into a consistent structure; or
normalizing timestamps across multiple chat transcripts to a standard time zone.

6. The method of claim 1, wherein the dashboard comprises:
a leaderboard of top issues based on a frequency of occurrence of respective generalized issues;
a heat map that visualizes a distribution of the respective generalized issues across different time periods;
identification of repeating issues that occur across multiple time periods;
suggestions for standardizing services to frequently occurring issues; or
identification of issues that should be added to the standardized knowledge database due to their frequency or impact.

7. The method of claim 1, wherein the dashboard comprises a trend analysis of a particular generalized issue over time.

8. The method of claim 1, further comprising applying a data estate layer comprising:
a chat space that stores the chat transcripts from the multiple chat groups; or
a data engineering pipeline that schedules or manages data flow from the chat space to subsequent processing layers.

9. The method of claim 1, further comprising applying a pre-processing layer to the chat transcripts prior to prompting the LLM, the pre-processing layer comprising:
data transformation that converts the chat transcripts into a structured format;
anonymization that removes personally identifiable information from the chat transcripts; or
text cleaning that removes irrelevant characters, standardizes formatting, or corrects common spelling or grammatical errors.

10. The method of claim 1, wherein clustering the vectorized initial issues comprises:
agglomerative clustering that groups similar vectorized initial issues based on their vector representations;
calculating a similarity score between clustered vectorized initial issues; or
filtering clusters based on the similarity score.

11. The method of claim 1, wherein the technological service comprises a fifth generation or later cellular network service or a satellite television service.

12. The method of claim 1, further comprising updating the standardized knowledge database based on a resolution of a support ticket.

13. The method of claim 1, wherein the dashboard provides a real-time update of an issue that is emerging across the multiple chat groups.

14. The method of claim 1, further comprising generating a confidence score for each respective generalized issue that indicates a level of certainty in accuracy of the respective generalized issue.

15. The method of claim 1, further comprising fine tuning the LLM based on feedback from a support agent account.

16. The method of claim 1, further comprising:
automatically generating an alert when a frequency of a particular respective generalized issue exceeds a predetermined threshold; and
sending the alert to a corresponding support team.

17. A non-transitory computer-readable medium that has instructions stored thereon that, when executed by at least one physical computing processor, cause a computing device to perform operations comprising:
receiving chat transcripts from multiple chat groups for a communications service provider where the chat transcripts include distinct support agent accounts of the communications service provider exchanging information about support tickets issued by subscribers who subscribe to a technological service provided by the communications service provider;
prompting a large language model (LLM) such that initial issues are generated based on the chat transcripts;
vectorizing the initial issues through semantic vector embedding;
clustering the vectorized initial issues such that issue clusters are formed;
applying a same or different LLM to each respective issue cluster of the issue clusters such that a respective generalized issue from the respective issue cluster is extracted and populated into a standardized knowledge database; and
resolving, by a support agent account, a support ticket at least in part by referencing a dashboard that provides an interface to the standardized knowledge database.

18. The non-transitory computer-readable medium of claim 17, wherein the dashboard comprises a trend analysis of a particular generalized issue over time.

19. A system comprising:
at least one physical computing processor of a computing device; and
a non-transitory computer-readable medium that has instructions stored thereon that, when executed by the at least one physical computing processor, cause the computing device to perform operations comprising:
receiving chat transcripts from multiple chat groups for a communications service provider where the chat transcripts include distinct support agent accounts of the communications service provider exchanging information about support tickets issued by subscribers who subscribe to a technological service provided by the communications service provider;
prompting a large language model (LLM) such that initial issues are generated based on the chat transcripts;
vectorizing the initial issues through semantic vector embedding;
clustering the vectorized initial issues such that issue clusters are formed;
applying a same or different LLM to each respective issue cluster of the issue clusters such that a respective generalized issue from the respective issue cluster is extracted and populated into a standardized knowledge database; and
resolving, by a support agent account, a support ticket at least in part by referencing a dashboard that provides an interface to the standardized knowledge database.

20. The system of claim 19, wherein the dashboard comprises a trend analysis of a particular generalized issue over time.
